(19) United States
(12) Patent Application Publication
(10) Pub. No.: US 2024/0006894 A1
(43) Pub. Date: Jan. 4, 2024

(54) ACTIVE CELL BALANCING IN BATTERIES USING SWITCH MODE DIVIDERS

(71) Applicant: Eric Paul Grasshoff, San Marcos, CA (US)

(72) Inventor: Eric Paul Grasshoff, San Marcos, CA (US)

(21) Appl. No.: 17/750,238

(22) Filed: May 20, 2022

Related U.S. Application Data
(63) Continuation-in-part of application No. 17/146,787, filed on Jan. 12, 2021.
Application No. 17/146,787 is a continuation-in-part of application No. 15/961,604, filed on Apr. 24, 2018, now Pat. No. 10,910,847.
(60) Provisional application No. 62/658,364, filed on Apr. 16, 2018.
(60) Provisional application No. 62/609,063, filed on Dec. 21, 2017.

(51) Int. Cl. H02J 7/00

(52) U.S. Cl. CPC H02J 7/0019; H02J 7/0047

(57) ABSTRACT

A battery cell balancing system contains a switch mode circuit employing voltage sensors across the cells and current sensors on the balancing legs to enable reliable and efficient cell balancing during battery charge.

### CROSS-REFERENCE TO RELATED APPLICATIONS

This application claims the benefit of and is a Continuation-in-Part of U.S. Utility patent application Ser. No. 17/146,787 filed on Jan. 12, 2021 which claims priority to U.S. Utility patent application Ser. No. 15/961,604 filed Apr. 24, 2018 and issued on Feb. 2, 2021 as U.S. Pat. No. 10,910,847 which claims priority from U.S. Provisional Patent Application No. 62/658,364 filed Apr. 16, 2018 and U.S. Provisional Patent Application No. 62/609,063 filed Dec. 21, 2017, all of which are incorporated by reference herein in their entirety.

### FIELD

The application relates generally to balancing battery cells during charging or discharging.

### BACKGROUND

Cells connected in series in rechargeable batteries tend towards an out-of-balance state when subjected to repeated charge/discharge cycles, or when left uncharged for long periods of time. This problem is common in rechargeable battery systems and is particularly acute in lithium-ion batteries (LIBs). Existing attempts to mitigate this out-of-balance problem have met with only limited success.

### SUMMARY

Accordingly, an assembly includes at least one switch mode divider (SMD) connectable in parallel to at least one respective battery cell and operable to equalize voltages between plural battery cells during charging of the battery cells, the SMD being characterized by an output voltage Vo that is a function of a duty cycle of a drive waveform and high and low rail voltages. The assembly also includes at least one circuit that generates a signal representative of current on a balancing leg to enable the SMD to limit balancing current to at least one of the cells during balancing.

In one or more embodiments, the circuit comprises a current sensor that generates the signal based on current sensed by the current sensor.

In one or more embodiments, the circuit comprises a controller that generates the signal based on an estimation of current.

In another aspect, an apparatus includes at least first and second battery cells arranged in electrical series with each other and defining a primary charge/discharge path. The cells connected in series include a positive terminal node, a negative terminal node and at least one node at a junction between two cells connected in series. A balancing circuit is arranged in electrical parallel with the primary charge/discharge path. The balancing circuit includes a voltage sensor line that includes at least one voltage sensor. The apparatus further includes a respective switch mode divider (SMD) connected to a respective cell junction. At least one controller controls the respective SMDs to equalize voltages between battery cells.

In another aspect, a method includes modulating at least one switch mode divider (SMD) associated with respective battery cells to equalize voltage between the battery cells. The SMD is characterized by being driven by a constant period signal having an ON time and OFF time, the sum of which equals a total constant period. The method further includes limiting current in at least one balancing leg associated with the at least one SMD to satisfy a threshold.

In another aspect, an assembly includes at least one switch mode divider (SMD) connectable in parallel to at least one respective battery cell and operable to equalize voltages between plural cells. At least one current sensor is associated with a balancing leg to enable the SMD to limit balancing current to at least one cell during charging.

In another aspect, a method includes modulating plural switch mode dividers (SMDs) associated with respective cells to equalize voltage between the cells during battery charge or discharge. The method further includes limiting current in at least one balancing leg associated with at least one SMD to satisfy a threshold. The threshold specifies the maximum magnitude of current that can pass through the balancing leg in either direction (positive or negative current).

The details of one or more embodiments of the invention, both as to its structure and operation, can best be understood in reference to the accompanying drawings and detailed description set forth herein. The claims however and the full scope of any equivalents when assigned their ordinary meaning to one of ordinary skill in the art are what define the scope of the invention.

### BRIEF DESCRIPTION OF THE DRAWINGS

FIG. 1 is a block diagram of an example system consistent with present principles;

FIG. 2 is a schematic diagram of a circuit for balancing cell voltage in accordance with one or more embodiments of the invention;

FIG. 2A is a schematic diagram of a circuit for balancing cell voltage in accordance with one or more embodiments of the invention;

FIG. 3 is a flow chart of example logic according to an example embodiment;

FIG. 4 is a schematic diagram of a circuit for balancing cell voltage during charging of a battery with multiple cells in series but without using hardware current sensors;

FIG. 4A is a schematic diagram of a circuit for balancing cell voltage during charging of a battery with multiple cells in series but without using hardware current sensors;

FIG. 5 is another schematic diagram of a circuit for balancing cell voltage during charging of a battery with multiple cells in series but without using hardware current sensors;

FIG. 5A is another schematic diagram of a circuit for balancing cell voltage during charging of a battery with multiple cells in series but without using hardware current sensors;

FIG. 6 is a flow chart of example logic according to an example embodiment of the invention;

FIG. 7 is a flow chart of example logic according to an example embodiment of the invention;

FIG. 8 is an illustration of a voltage waveform that is generated by a cell impedance measurement method.

FIG. 9 is an illustration of an unfiltered waveform that may be generated during cell impedance measurement.

FIG. 10 is an illustration of a waveform after filtering.

FIG. 11 is an illustration of a waveform showing exemplary time intervals for measuring voltage and current values.

### DETAILED DESCRIPTION

This disclosure relates generally to managing the states of charge (SOCs) of cells in batteries and has particular relevance to managing the SOCs of cells in rechargeable batteries that use cells that have low impedance, one example of which is Lithium-ion batteries. A system herein may include batteries, components powered by the batteries, and battery management assemblies that may include one or more computing components to control charging, discharging and/or balancing. Battery management assemblies may include one or more processors executing instructions that configure the assemblies to control the SOCs of the cells consistent with present principles. As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device, or an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The following terms may be used herein:

Battery Capacity—the amount of energy available in a battery, typically expressed in Amp-hours (Ah) or Watt-hours (Wh) for larger batteries.

Cell—is an electrical energy storage unit, typically consisting of an anode, a cathode, an electrolyte, and a separator. A battery can consist of a single cell or many cells connected in series and/or in parallel. In the context of balancing a battery, a group of cells connected in parallel is treated as a single large cell.

State of Charge (SOC)— the amount of energy available in a cell or battery at any given moment, typically stated as a percent of Full Battery Capacity (FBC).

State of Health (SOH)— an indication of the present Full Battery Capacity (FBC) of a battery relative to the battery's Nominal Battery Capacity when it was new. For example, if the nominal capacity of a battery (when new) is 200 Ah, and after some period of use the FBC drops to 160 Ah, then the SOH of the battery is 80%.

Primary Charge Path—refers to a charging path straight down the series of battery cells.

Balance— A battery is balanced when, at the terminal stage of charging, the cell voltages have been equalized in which every cell (where “cell” can be a group of individual cells connected in parallel) is at Full Charge Voltage and charging has typically continued thereafter until the balancing current has dropped to a threshold low level as further explained below, at which point the battery is balanced.

Equalize—is used to describe the process of reducing differences in cell voltages during the balancing process with a goal of bringing a battery into balance.

Note that “balanced” and “out of balance” are relative terms. For present purposes, a battery is considered balanced if the SOCs of all the cells in the battery are within approximately ±1% of each other.

Balancing Current—refers to the differences in charge (or discharge) current applied to a subset of the cells in the battery to attempt to bring the cells into balance.

Balancing Leg—refers to a conductive path that is off the Primary Charge Path and that is used for applying charge or discharge currents to a subset of cells in an attempt to balance the battery.

True Battery Capacity—is the capacity of a battery when every cell in the battery is charged to 100% SOC.

Available Battery Capacity—the capacity of a battery at any given instant.

Nominal Battery Capacity—refers to nominal capacity of a battery when new.

Full Battery Capacity—refers to the available capacity in the battery after the battery management system has charged the battery as fully as the battery management system is capable of.

True Battery Capacity vs. Full Battery Capacity—If a charging system cannot or does not bring every cell up to 100% SOC at the end of a charge cycle, then Full Battery Capacity will be less than True Battery Capacity.

Cell Voltage—the voltage of a cell at any instant.

Nominal Voltage—the average or mean voltage of a cell or battery over the flat region of the discharge curve.

Full Charge Voltage—the voltage to which a cell or battery is brought to at the end of a charging cycle.

Cell Impedance—refers to cell voltage divided by cell current.

Dynamic Impedance—the first derivative of the voltage with respect to current—dV/dI.

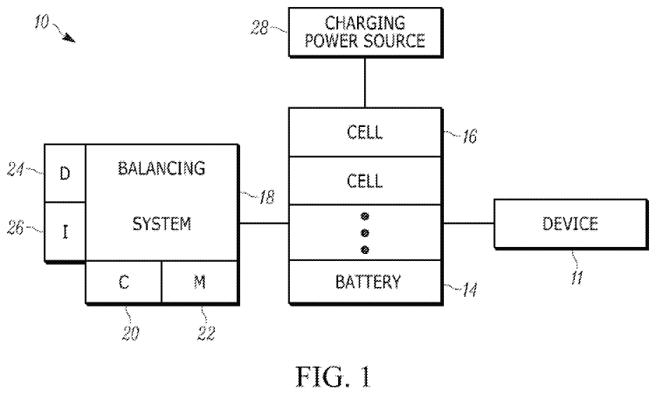

Now specifically referring to FIG. 1, an example system 10 is shown, which may include one or more of the example devices mentioned above and described further below in accordance with present principles. The first of the example devices included in the system 10 is a device 11, such as the motors in an electric vehicle, or the electrical system in a house or commercial building, or an electric power grid.

The device 11 may be powered by a rechargeable battery 14, such as a Lithium-ion battery with plural cells 16 connected in electrical series, it being understood that while only a single connection is shown between the battery 14 and device 11, more than one electrical line typically connects the battery to the device. The battery 14 may be removably or non-removably coupled to the housing of the device 11. A Lithium-ion battery may be implemented by any battery that uses lithium, including batteries that use cathodes with chemistries such as Lithium Iron Phosphate, Lithium Cobalt Oxide, Lithium Nickel Manganese Cobalt Oxide, Lithium Manganese Oxide, Lithium Nickel Cobalt Aluminum Oxide, Lithium Titanate, or any other battery chemistry that uses lithium ions. While present principles envision, in example embodiments, use in connection with Li-ion batteries, present principles contemplate use with any appropriate stored energy source or storage element, in particular (though not exclusively) those that exhibit a low impedance characteristic during charge/discharge.

As discussed further below, a balancing system 18 can be electrically connected to the battery 14. The balancing system 18 can be incorporated all or in part within the housing of the device 11 or it may be separate therefrom. The balancing system 18 can be enclosed inside the battery case or it can be disposed outside the battery case.

Among the components of the balancing system 18 that are more fully disclosed below are at least one controller 20 and at least one data storage medium 22.

The data memory 22 may be, without limitation, disk-based or solid-state storage that is not a transitory signal. The memory may be removable media.

In any case, as discussed further below, the balancing system 18 acts to equalize the voltages of the individual cells 16 during charging from a charging power source 28, or during battery discharge, or while the battery is idle (not charging or discharging).

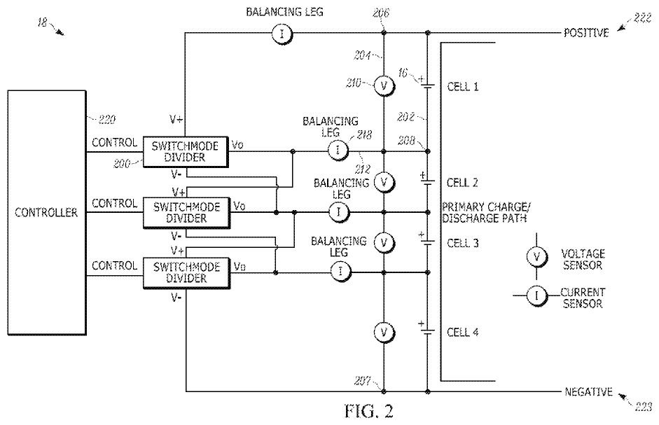

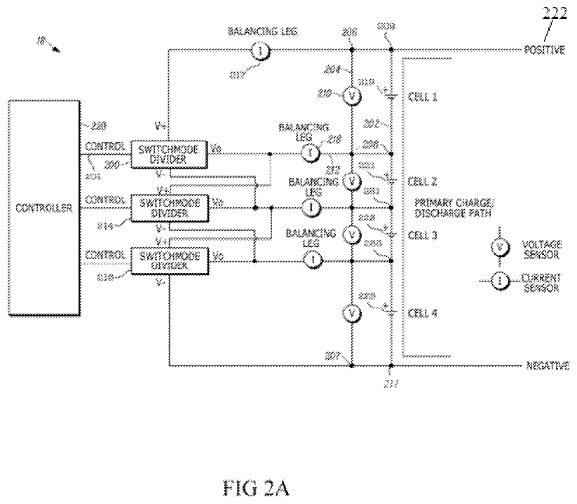

Turning now to FIG. 2A for a more detailed depiction of an example balancing system 18, the balancing system 18 includes plural switch mode dividers (SMDs) 200, 214 and 216. As understood herein, a balancing system that uses SMDs can overcome limitations of less efficient balancing systems. The low impedance current paths of SMDs provide higher efficiency at moving energy to balance cells in the battery as compared to balancing technologies which do not employ switch mode dividers. But the low impedance of SMDs results in a control system with high loop gain, rendering the control loop very sensitive to even the most modest differences in voltages of the cells 16. Current sensors 218 in the below-described balancing legs 212 of the balancing system 18 are used to determine whether the current in the balancing legs 212 is within a threshold range that is specified by the below-described threshold(s) for the balancing system 18. This current measurement enables the balancing system 18 to limit the loop gain of the circuit, resulting in more effective control of the high-gain loop.

In general, and prior to describing the details of the balancing system 18, the SMDs 200, 214 and 216 are high power (low impedance) voltage dividers. The output voltage Vo of each SMD 200, 214 and 216 is a function of the duty cycle of the control waveform that is transmitted on control lines 201 and of the high and low rail voltages (V+ and V−) of the respective SMD 200, 214 and 216.

In accordance with switch-mode circuit techniques, each SMD 200, 214 and 216 is driven by a constant period signal having a unique ON time and OFF time, the sum of which two times is essentially equal to a total constant period. SMD modulation takes the form of Pulse Width Modulation (PWM) in that the ratio of ON time to total period (also defined as duty cycle) is adjusted to vary the output voltage Vo in direct correspondence.

If the duty cycle is 50%, the output voltage Vo will be at the midpoint between the high rail voltage and the low rail voltage. The low impedance of the SMD-based balancing system 18 allows relatively large balancing current levels to be applied to the cells 16 at very high efficiency. Because SMDs 200, 214 and 216 and Li-ion cells 16 are very low impedance devices which are essentially connected in parallel, a very small change in the duty cycle, creating a small voltage difference, produces a relatively high corresponding level of differential balancing leg current. When changing the voltage that is applied to low impedance cells to charge and/or balance them, the resulting high-gain response can create feedback instability for the balancing system 18, a problem that is addressed by use of the below-described current sensors 218 in the balancing legs 212.

Accordingly, and turning to the details of FIG. 2A, plural battery cells 16, in the example shown four cells 219, 221, 223 and 225, are arranged in electrical series with each other as shown to define a primary charge/discharge path 202. The series of cells comprises a battery that has a positive terminal 209 and a negative terminal 211 and a primary charge/discharge path 202. The balancing circuit 18 is arranged in electrical parallel with the battery 14 as shown.

The output voltage signal Vo of each SMD 200, 214 and 216 is connected to a respective junction 208, 231 and 233 between a pair of adjacent cells with a current sensor 218 on each balancing leg between the output from each SMD 200 and the respective cell junction. The high rail V+ of each SMD 200, 214 and 216 is connected to the positive terminal of the upper cell of the pair of cells, and the low rail V− of each SMD 200, 214 and 216 is connected to the negative terminal of the lower cell of the pair of cells.

For example, Vo of a first SMD 216 is connected to the junction 233 between the two lowest cells in the battery 223 and 225. The low rail V− of SMD 216 is connected to the negative terminal 211 of cell 225 and the high rail V+ of SMD 216 is connected to the positive terminal of cell 223 (which is at cell junction 231).

In another example, Vo of a second SMD 214 is connected to the junction 231 between cell 221 and cell 223. The low rail V− of SMD 214 is connected to the negative terminal of cell 223 (at cell junction 233). The high rail of SMD 214 is connected to the positive terminal of cell 221 (which is at cell junction 208).

As a final example, Vo of a third SMD 200 is connected to the junction 208 between cell 219 and cell 221. The low rail V− of SMD 200 is connected to the negative terminal of cell 221 (at cell junction 231). The high rail of SMD 200 is connected to the positive terminal 209 of cell 219.

Note that the balancing legs 212 can function as nodes for the output voltage Vo of the SMDs as well as paths for balancing current.

A voltage sensor line 204 comprises a plurality of voltage sensors 210 connected in series. Each individual voltage sensor 210 is connected in parallel to one respective cell. Each voltage sensor 210 may generate a signal representative of cell voltage of the respective cell 16.

The voltage sensors 210 are communicatively coupled to the controller 220 as described further below, so that the controller 220 receives voltage information from the respective voltage sensor 210.

The output voltage Vo of each SMD 200, 214 and 216 is connected via a respective balancing leg 212 to the respective cell junctions 208, 231 and 233. A respective current sensor 218 is electrically connected to the balancing legs 212 to generate a signal representative of current through the respective balancing leg 212. Note that the current sensor 217 shown in FIG. 2A in the top-most positive line that includes the positive node 209 is optional. Each current sensor 218 is communicatively coupled to the controller 220 so that the controller receives balancing leg current information from the current sensors 218.

Accordingly, at least one controller 220, preferably a digital microcontroller, is connected to the SMDs 200, 214 and 216 via control lines 201 to modulate the SMDs 200, 214 and 216 to establish the output voltage Vo of each SMD 200, 214 and 216 that adds to or subtracts from the voltage on the primary charge path 202 for the respective cells 16 to maintain current on the balancing legs 212 within certain limits as explained further below.

In establishing the output voltage Vo, the duty cycle of the SMD 200 is increased to raise the output voltage and decreased to lower it as discussed above and further explained below.

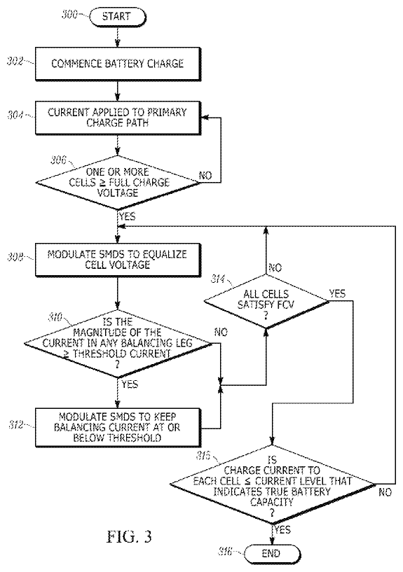

FIG. 3 illustrates the operation of the balancing system 18 during a charging cycle. The process begins at start state 300. Battery charge is commenced at block 302 on a battery 14 with each cell 16 at any SOC, typically below Full Charge Voltage, and with the cells 16 in any condition of balance or out-of-balance. Block 304 indicates that charging is commenced by applying charge current, flowing from the positive to negative terminals on the primary charge/discharge path 202. The magnitude of the current on the primary charge/discharge path 202 may typically be greater than the magnitude of the balancing current on the balancing legs 212.

The voltage of each cell 16 is monitored using the respective voltage sensors 210. When it is determined at decision diamond 306 that at least one cell 16 reaches or exceeds Full Charge Voltage (FCV), the logic proceeds to block 308 to modulate the SMDs 200 to equalize the cell voltages. That is, in example implementations, cell voltage equalization with current-limiting operation discussed below starts only when a first cell 16 reaches FCV. In other embodiments, the balancing circuit 18 may start operating before any cell 16 reaches FCV, in which instance input from the current sensors would be used by the controller to limit current through the balancing legs to be no more than a threshold current magnitude before at least one cell reaches full charge voltage during battery charge.

Should a cell 16 reach a voltage above full charge voltage as indicated by the respective voltage sensor 210 of the cell 16, the controller 220 lowers the voltage of the cell 16 by modulating the SMD 200 that is associated with the over-voltage cell 16 to reduce the cell's voltage at a controlled rate until the voltage is at or just below FCV.

As the SMDs 200 are being used to alter the cell voltages, the logic at decision diamond 310 determines whether the magnitude of the balancing current (positive or negative) as measured by any current sensor 218 is at or beyond a threshold value, typically a maximum allowed current magnitude. This applies to limiting both negative and positive current, because balancing current can flow in either direction. Note that one threshold may be used for negative current and another, different threshold may be used for positive current, or a single threshold may apply to both. Should the magnitude of any balancing leg current satisfy the threshold, e.g., by being at or beyond the threshold at decision diamond 310, for instance as a result of having applied modulation of block 308 at an excessive rate of change, the logic moves to block 312 to modulate the SMDs 200 to adjust the voltages of adjacent cells 16 to bring the balancing leg current magnitude at or below the threshold.

In other words, if at any time during the balancing process, the output voltages Vo are adjusted in a manner that results in the magnitude of the current in any balancing leg 212 to be at or beyond the limit threshold, then the modulation of an SMD 200 that is at and/or adjacent to the balancing leg 212 with excessive current is adjusted to reduce the voltage differential between the cell 16 that has excessive balancing current and one or both of the cells that are adjacent to cell 16.

The controller 220 preferably establishes as much of the allowed magnitude of balancing current as possible, albeit always below the maximum permitted threshold, to provide for the fastest charging and balancing without violating the threshold for balancing leg current magnitude. Thus, in example embodiments the balancing current magnitude is maintained at a high level at or below a threshold to prevent overcurrent conditions that could damage the system or pose a safety hazard.

In modulating the SMDs 200, if the controller 220 determines, based on the signal from a balancing leg current sensor 218, that the current flowing in the balancing leg 212 is too high (e.g., above the threshold) in the positive direction then the duty cycle of the control signal is reduced to lower its output voltage Vo. On the other hand, if the current in the balancing leg 212 is too great in the negative direction then the controller 220 increases the duty cycle of the control signal and thus raises the output voltage Vo.

Monitoring of voltage and current data and modulation of the SMDs continues preferably until at least one and more preferably two conditions are met. As indicated at decision diamond 314 it is determined whether all cells 16 have reached FCV. If not, the process loops back to block 308. If all cells have reached FCV, the logic can move from decision diamond 314 to decision diamond 315, which applies the logic for a constant voltage (CV) charge cycle. Decision diamond 315 determines whether the balancing current to each cell has decreased to a level indicative of the battery 14 having reached True Battery Capacity. If so, the process ends at state 316. Otherwise, the logic loops back to block 308.

Note that the controller 220 samples all cell voltages as indicated by the voltage sensors 210 for ongoing modulation of the SMDs 200 to equalize cell voltages while maintaining balancing leg current magnitudes at or below the threshold for balancing currents. When output voltage Vo at any one cell 16 is altered, it will affect the adjacent cells 16 and adjacent balancing leg currents because the cells 16 are connected in series, so modulation and adjustment of the output voltages of the SMDs 200 is typically an ongoing process while the balancing system 18 is operating.

If desired, the threshold magnitude for the balancing leg current may be established as a function of battery capacity, chemistry of the battery, design of the battery, and use environment. In general, the threshold magnitude of the balancing leg current is selected to be a suitable percentage of the maximum permissible charging current based on the design objectives of the battery system. A higher balancing current threshold allows the battery 14 to reach a balanced state in a shorter time, but a too-high threshold can lead to cell or system damage, so the threshold is established to ensure current in the balancing leg 212 remains below stress levels of the cells or the system.

As an example, in some batteries a balancing current range threshold of 5% to 10% of the maximum primary charge current is typically sufficient to ensure 100% balancing within an hour or two under conditions of the battery 14 and cells 16 that would typically occur. The closer the SOCs of the cells 16 are to each other, the lower the balancing range required to achieve complete balance over any given time period. Some designers may opt for a lower range of 2% to 3% of maximum primary charge current, for example, to save cost; while others may opt for a higher range (20% or 30% of maximum primary charge current, for example) if faster balancing times are more important than system cost.

It may now be appreciated that currents on the balancing legs 212 can be advantageously used as proxies for the charge current to each cell 16 in the primary charge path 202. As understood herein, current in the balancing legs 212 correlates closely enough to the main charging current on the primary charge path 202 that it can be used to determine when each cell 16 has reached 100% SOC. This allows the current sensors 218 to be placed on the balancing legs 212 and allows use of current sensors 218 with much lower current rating than would be needed to sense current on the primary charge path 202. The use of two inputs—current on the balancing legs 212, and voltage on each cell 16—enables very high efficiency (from the switch mode circuit) and very good stability (from the availability of current data from the current sensors 218). Moreover, the balancing circuit 18 can reliably, efficiently, and accurately bring every cell 16 in the battery 14 up to 100% SOC at the end of every complete charge cycle. In other words, by monitoring cell voltage and balancing leg current, the controller 220 can detect when cells 16 reach Full Charge Voltage and then subsequently reach 100% SOC. When a cell 16 first reaches Full Charge Voltage, it is usually not yet at 100% SOC, so additional charging is typically required after Full Charge Voltage to bring the cell 16 up to 100% SOC, which is made possible by the balancing leg current sensor 218 input, which enables accurate, reliable determination of when a cell 16 has reached 100% SOC. An indication of 100% SOC occurs when a cell 16 is at Full Charge Voltage as indicated by the respective voltage sensor 210 and current to the cell 16 as indicated by the current sensor 218 associated with the cell 16 has dropped to a very low level, typically around 0.05 C to as low as 0.01 C, wherein “C” is a measure of current rate relative to a capacity of the cell.

Furthermore, locating the current sensors 218 on the balancing legs 212 avoids compromising the battery's primary charge path 202.

In addition to enabling management of the inherent differences in voltage among the various cells 16, using the balancing current as an input to the feedback loop used by the controller 220 mitigates the instability disadvantage of the low impedance SMD 200 configuration while maintaining all the added advantages of that configuration. Using the current sensors 218, cell voltages need only be approximately measured, while limiting the current in the balancing legs 212 to a finite maximum level effectively eliminates potential loss of control of a high-gain balancing system.

Still further, current and voltage sensors of relatively low accuracy (typical accuracy of 2% of maximum cell voltage for the voltage sensors 210 and 0.03 C for the current sensors 218) are sufficient because the accuracy (or resolution) of voltage and current measurement only needs to be great enough to detect possible runaway current conditions and make corrections to prevent them, and to ensure that cells 16 do not rise above Full Charge Voltage and/or do not approach Maximum Cell Voltage (the maximum voltage a cell can be charged to without incurring risk of damage to the cell.)

Also, current sensors 218 on the balancing legs 212 can be rated to be relatively small and inexpensive as compared to current sensors that might be placed in the primary charge path 202; the current sensors 218 on the balancing legs 212 do not siphon off energy from primary charge path 202, which would reduce the efficiency of the system; and unlike larger current sensors on the primary charge path, balancing leg current sensors do not generate undue heat.

Because high charge current can be efficiently and safely applied throughout the charge cycle, with charge current dropping to a low level as any cell 16 reaches 100% SOC, faster charge cycles than currently are provided are realized by the balancing circuit 18. Furthermore, the balancing circuit 18 can balance cells 16 that are significantly out of balance. As long as no cell 16 is defective (essentially, as long as all cells can be charged), the balancing circuit 18 can bring every cell 16 in the battery 14 up to 100% SOC and into balance with all of the other cells 16 in the battery 14, regardless of the SOC of each cell 16 at the start of the charge cycle.

Variations in cell characteristics do not affect the balancing performance of the balancing circuit 18. In other words, the balancing circuit 18 can fully charge and balance a battery regardless of variations in cell characteristics.

The SMDs 200 are modulated by the controller 220 to independently regulate the balancing current to each cell 16 until each cell 16 reaches Full Charge Voltage and high impedance, at which point each cell 16 has reached 100% SOC. In non-limiting embodiments, this can be accomplished while minimizing stress on the cells by modulating the SMDs 200 to establish cell voltages that will bring low voltage cells 16 up rather than bringing high voltage cells 16 down, thereby minimizing current shunting between cells 16. In general, but without limitation, cells 16 can be brought from a discharged state up to a fully charged state in a steady upward charge cycle, with very little or no discharges from individual cells 16 as part of the balancing scheme during charging.

In addition to the advantages noted above, the present balancing circuit 18 eliminates the need to discharge cells 16 through load resistors to maintain balance and overcomes limitations on balancing range that are inherent in some systems. The present balancing circuit 18 enables use of current sensors 218 rated for only a small fraction of the ampacity of the battery, which reduces cost of the current sensing system. The full main charge current can be applied for most of the charging cycle with the balancing circuit 18 preferably switching on only when at least one cell 16 reaches Full Charge Voltage. At this point the other cells 16 have also been charged for some time and will typically be close to Full Charge Voltage. Accordingly, in example embodiments the cell balancing is performed by the balancing circuit 18 only near the end of each charge cycle when all of the cells are near Full Charge Voltage and only a small amount of balancing current is needed to quickly balance the cells and bring all of them to 100% SOC.

While the above-described balancing process contemplates cell equalization during battery charge, the same principles also may be used during battery discharge. In an embodiment, the logic in controller 220 balances the cells 16 in the battery 14 during a discharge cycle (typically when the battery 14 is powering a load). The logic that equalizes cell voltages while limiting the current on the balancing legs 212 thus may be employed during discharge cycles as well as during charge cycles.

As understood herein, balancing during discharge cycles and/or while the battery is idle can increase the available capacity of the battery 14. A battery management system that is typically provided for a battery will electrically disconnect the battery from the load when any cell in the battery 14 has reached a minimum cell voltage. Typically, the weakest cell in the battery will reach minimum voltage first. On the other hand, if a battery is balanced during discharge, stored energy in higher voltage (or higher SOC) cells will be transferred to cells with lower voltage (or lower SOC), thereby increasing available battery capacity.

With the present balancing circuit 18, there is no need to collect, store and analyze data on battery charge and discharge cycles to try to mitigate inherent inaccuracies in estimating SOC.

Next a method for approximation or estimation of balancing leg current will be described in example embodiments where a balancing system as described herein does not include hardware current sensors on balancing legs as described above. Thus, it is to be understood consistent with present principles that in lieu of a specific hardware current sensor that physically senses current through a balancing leg, estimations of current along balancing legs may also be used consistent with present principles. Without limitation, estimating balancing current as described below may be referred to as Impedance Limited Current Sensing (ILCS).

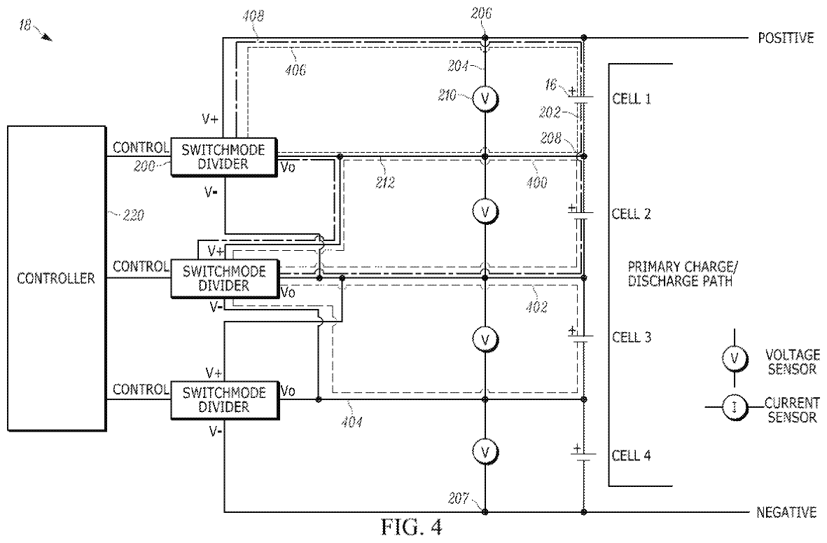

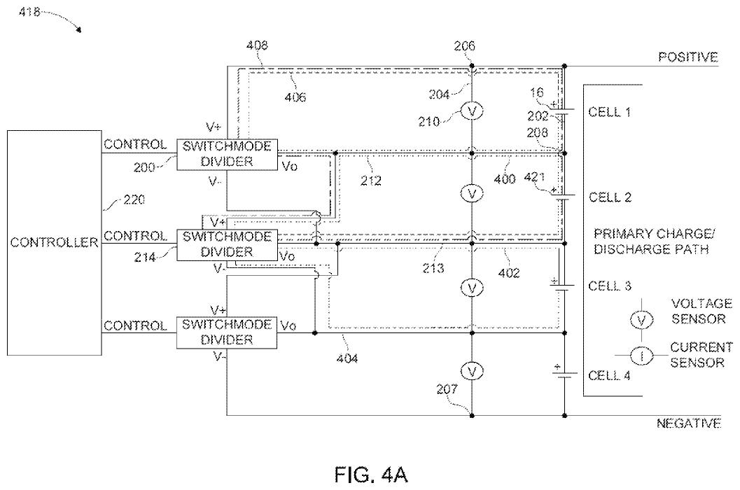

FIG. 4A again illustrates a balancing circuit 418 but with the current sensors 218 excluded from the balancing circuit 18 of FIGS. 1 and 2A.

FIG. 4A includes illustrations of three conductive loops in the balancing circuit 418. These loops are designated 400, 402 and 406. Each of these loops consists of (a) one SMD 200; and (b) one cell 16 that is connected to the balancing leg 212 associated with the SMD 200; and (c) the conductive paths that complete the loop between the SMD 200 and the respective cell 16. These loops are called SMD-Cell Loops.

SMD-Cell Loops may thus include a relatively low-impedance circuit paths that include two or more voltage sources connected in parallel. For example, the parallel voltage sources in SMD-Cell Loop 406 are the cell 16 and the output voltage Vo from SMD 200.

If the parallel voltages are exactly equal, then zero current will flow in the respective SMD-Cell Loop. Thus, Ohm's Law I=E/R (with “E” being voltage in this case) where E=0 will result in a current I=0 for all non-zero values of R (resistance). When the balancing system is operating, the output voltage Vo for the respective SMD 200 may be adjusted in accordance with the algorithm of FIG. 3 to cause a corresponding balancing current to flow in the balancing leg circuit path. The current flowing in the respective balancing leg 212 and thus the resultant balancing current that is applied to the respective cells may be limited to a threshold level at or below the design limit of the system as described above in FIG. 3 as the threshold current, thereby preventing excessive current that can stress and/or damage the system.

Note that two SMD-Cell Loops are associated with each SMD. For example, SMD-Cell Loops 400 and 406 share a common balancing leg 212 that connects the output voltage Vo of SMD 200 to the cells that comprise the cell junction 208 that the balancing leg 212 connects to. SMD-Cell Loop 406 contains the cell 16 that is on the positive side of junction 208 and SMD-Cell Loop 400 contains the cell 421 that is on the negative side of junction 208. The currents on the two SMD-Cell Loops 400 and 406 add together to form the total balancing current on balancing leg 212.

An ILCS system as illustrated in FIG. 4A (where there are no hardware current sensors) may be used where the controller 220 calculates an approximation of the current on the respective balancing leg 212. It may do so by characterizing the impedance of the respective SMD-Cell Loops (which typically may be done at the time of design or assembly of the system 418 as further described below), estimating the voltage Vo on the respective balancing leg 212 as controlled by the respective SMD 200, and receiving data from the respective voltage sensors 210 of the respective SMD-Cell Loops 400 and 406 that are adjacent to the respective cells 16 connected to the balancing leg 212. With these three parameters, the controller 220 may estimate (using Ohm's Law) the current flowing in the respective balancing leg 212 without the use of a hardware current sensor 218 to perform a direct measurement of the actual balancing leg current.

In non-limiting examples, the current flowing in any given balancing leg may be the algebraic sum of the currents flowing in all of the various loops in the system 418, which include the respective balancing leg or legs, one or more corresponding SMD outputs Vo, and one or more corresponding battery cells. Loop 408 is an example of a current loop in system 418 that contributes to the total current flowing on balancing leg 213, but which is not an SMD-Cell Loop per se, because loop 408 comprises two SMDs (200 and 214) and two cells (16 and 421). Loop 408 has a second-order effect on the balancing current on balancing leg 213 relative to the contributions of SMD-Cell Loops 400 and 402. If there are additional cells in series in the battery, the further the cells are from the SMD-Cell Loop that is being characterized, the smaller the impact these cells may have on the current on the balancing leg in question. Nonetheless, it may be desirable to compensate for the impact that these other cells in the battery have on the balancing current in a balancing leg that is being characterized.

The application of Thevenin's Theorem allows the reduction of the balancing leg current to a simplified function proportional to the Vo voltage on the respective balancing leg 212 and the combined (Thevenin equivalent) loop impedance of the associated current paths and the impedance of the cell(s) 16 as shown in FIG. 4A.

In non-limiting practical applications, each SMD may be connected to multiple cells using conductive paths of copper wire, connectors, and copper printed circuit board (PCB) traces. However, note that other suitable materials besides copper may also be used. Regardless, the Vo voltage of the various SMD outputs may still be adjusted by the controller 220 using the algorithm of FIG. 3 but note that the specific value at which any Vo should be set using the algorithm of FIG. 3 can be estimated even without input from a current sensor indicating a respective current in a respective balancing leg because the value of Vo is a direct function of the duty cycle of the corresponding SMD (as modulated by the controller 220) and its associated voltages V+ and V− (which may be measured by the respective voltage sensor(s) 210 in the respective loop). Employing ILCS, the impedance of all elements in the loop (including cell impedance) may be characterized and the value of Vo can be approximated by calculating an estimate of the respective balancing leg current.

The characteristic impedance of the Vo output for each SMD may be a function of the total loop impedance of the respective SMD circuit. Items that contribute to Vo output impedance may include the SMD switches (such as field-effect transistors (FETs) and/or comparable bipolar transistors), the filter inductor impedance of the SMD and the filter capacitor impedance of the SMD, and the various circuit board traces that connect these circuit elements to the Vo output electrode.

As a practical consideration, the impedances of loops such as 400, 402, 406 and 408 may be a known parameter that can be determined when the system is designed, as the impedances of the loops are a function of the circuit connections that include components and conductive paths inside the SMD as well as wires, connectors and any other conductive paths between the Vo output electrode and the battery cells. Alternatively, the impedances of loops such as 400, 402, 406 and 408 can be determined empirically (by measurement), for example at time of manufacture.

Note that the impedances of individual components in the loop and the copper wire and connectors can vary with temperature and therefore if variations in impedance due to temperature fluctuations should be accounted for in a given implementation, temperature fluctuations can be determined using temperature sensors within the system 418. The temperature sensors might be located, for example, at or adjacent to the battery cells themselves and/or somewhere along the printed circuit board (or other components) that comprise the system 418. Temperature coefficients for the various components and elements of the system 418 could be stored locally, for example in a look-up table or database, and these temperature coefficients could be applied to temperature measurements taken with the temperature sensors to calculate or estimate the loop impedances, corrected for the instant local temperature. The database or look-up table may be populated based on empirical determinations made by the battery manufacturer prior to vending. Alternatively, a temperature/impedance coefficient can be calculated or estimated for the entire system 418 and this aggregate temperature coefficient can be applied to changes in temperature to estimate changes in impedance of the system 418.

To employ ILCS as a method of sensing current on the balancing legs, a basic transfer function from the PWM value of the respective SMD to the resulting balancing leg current can be established. This transfer function may be affected by multiple factors and as described herein may only need to be approximate to ensure that the high and low extents of the PWM duty cycle may be limited such that the range of resultant Vo values based on current estimation produce a balancing leg current at or below a desired threshold current magnitude. This threshold may be referred to as a second threshold current magnitude that may be a predetermined amount less than the first threshold current magnitude described above (which is the maximum permitted threshold used to prevent overcurrent conditions). The second threshold current magnitude, which may be used in the ILCS method, may be set at a magnitude less than the first threshold current magnitude to safeguard against coming close to or exceeding the first threshold current magnitude.

For any given SMD in the system 418 the parallel voltages can be reduced to three values: the output voltage Vo of the corresponding SMD and the voltages as measured by the voltage sensors 210 of the corresponding two cells connected to the respective balancing leg. In accordance with Ohm's Law, the algebraic sum of these voltages when divided by the combined characteristic impedance of the respective loops containing those voltages may provide an approximation of the balancing leg current for the respective balancing leg.

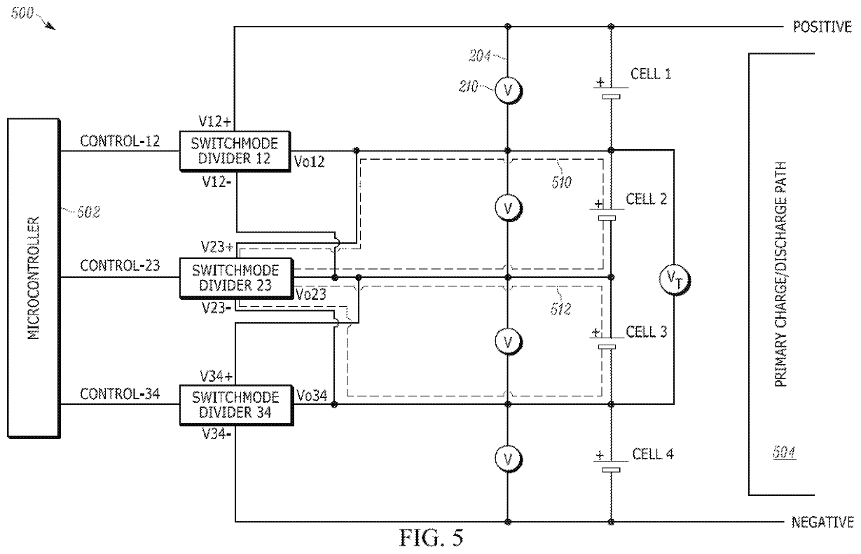

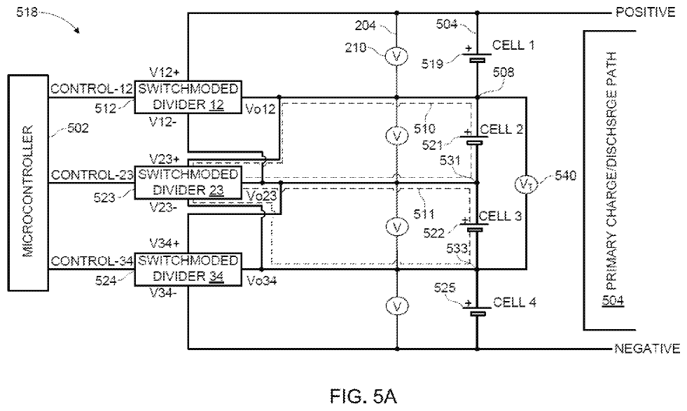

Next, a numeric example of estimating Vo using ILCS will be provided in reference to a four-cell battery configuration as shown in FIG. 5A. As may be appreciated from FIG. 5A, a balancing system 518 may be similar in many respects to the system 18 and include many of the same components arranged similarly as in the system 18, including a controller 502 and primary charge/discharge current path 504 for four cells arranged in series. This example shows how to estimate output voltage Vo23 as a function of the duty cycle applied to SMD23 523 so as to maintain the balancing current within a range of ±2.5 A, which (in this example) may be the second threshold current magnitude referenced above.

Describing FIG. 5A, the output Vo23 may be connected to the junction 531 of CELL2 521 and CELL3 522. The high and low rail electrodes (V23+ and V23−) of the SMD23 523 may be connected respectively to the positive terminal of CELL2 521 at junction 508, and to the negative terminal of CELL3 522 at junction 533.

The input signal to SMD23 523 may be a square wave signal. The PWM duty cycle of the square wave signal may be generated by the microcontroller 502.

In one example embodiment, the high time of the square wave control signal connects V23+ to Vo23 and the low time of the square wave control signal connects V23− to Vo23. Note that V_{T} 540 shows where the voltage difference between the top of CELL2 521 at junction 508 and the bottom of CELL3 522 at junction 533 may be measured and is not an indication that there is a voltage sensor from the top of CELL2 521 to the bottom of CELL3 522 designated as “V_{T}”. Rather, V_{T} 540 just illustrates where/how V_{T} 540 may be measured in this example by adding together the values from the respective voltage sensors 210 connected in parallel to CELL2 521 and CELL3 522.

The duty cycle of the square wave control signal may be expressed as a scalar value between zero and one, as illustrated in the following three examples. First, a duty cycle of 1.00 may connect V23+ to Vo23 continuously. Second, a duty cycle of 0.00 may connect V23− to Vo23 continuously. Third, a duty cycle of 0.50 may connect V23+ and V23− to Vo23 alternately and for equal time periods.

Thus, a duty cycle of 0.50 may produce a symmetrical square wave which results in a value of Vo23 midway between V23+ and V23− for SMD-23 523, which may be expected behavior of an SMD.

Accordingly, when the balancing system 518 is active, the respective SMD may generate a low impedance divided voltage, Vo, which may always be between V+ and V− according to the duty cycle of the square wave control signal. Modulating the duty cycle of the control signal may therefore generate a voltage at Vo that ranges between V+ and V−, depending on the duty cycle of the control signal.

Note that a theoretically perfect circuit would have the following characteristics. First, both switches in the SMD would have zero impedance when on, and infinite impedance when off. Second, the filter inductor in the SMD would have zero resistance. Third, the connections to the cells (wires and printed circuit board traces) would have zero resistance. Fourth, the respective battery cells would have zero impedance and equal voltages. With a theoretically perfect circuit, a control duty cycle of exactly 0.50 would result in a Vo value exactly equal to the voltage at the junction of the two battery cells. In this case, zero current would flow in the balancing leg because the circuit would be exactly balanced. (Note: In this context, “balanced” refers to the condition of the theoretically perfect circuit and not to the relative SOCs of the cells in the battery.) Thus, under these theoretical ideal conditions, any duty cycle other than 0.50 would imbalance the circuit and produce theoretically infinite current.

But in a real-world circuit, the aforementioned elements from the immediately preceding paragraph may have a finite nonzero resistance or impedance. As such, the duty cycle can be varied to produce an at least somewhat predictable, finite current on the balancing legs.

Two SMD-Cell Loops are highlighted in FIG. 5A. A first SMD-Cell Loop 510 may begin at V23+ of the SMD-23 523 and extend to the positive terminal of CELL2 521, across CELL2 521, to the negative terminal of CELL2 521, then on to the balancing leg of SMD-23 523, across to the positive side of SMD-23 523, and back to V23+ of SMD-23 523. As also shown in FIG. 5A, a second SMD-Cell Loop 511 may begin at V23− of SMD-23 523, extend to the negative terminal of CELL3 522, across CELL3 522 to the positive terminal of CELL3 522, on to the balancing leg of SMD-23 523, then across SMD-23 523 and back to V23− of SMD-23 523.

Currents flow in the same direction at the balancing leg around SMD-Cell Loops 510 and 511, and so current flowing around SMD-Cell Loops 510 and 511 will always be additive at the common balancing leg to create the total current in the balancing leg of SMD-23 523.

A numerical example will now be provided that uses impedance values that may be seen in a real-world circuit to illustrate how to calculate PWM duty cycles that would yield a maximum (absolute value) balancing current flowing in the balancing leg connected to Vo23 for the second threshold current magnitude referenced above when using the ILCS method. In this example, the second threshold current magnitude is ±2.5 A.

According to this example, assume each cell has an impedance of 0.004Ω. The two SMD-Cell Loops 510, 511 may be connected in parallel, and so the parallel combination of cell impedance for this example is 0.002Ω.

The impedance values in the table below may be representative of materials at a temperature of 25° C.:

| | |
|---|---|
| SMD Vo output impedance | 0.083 Ω |
| PCB trace copper | 0.006 Ω |
| Cell wiring | 0.015 Ω |
| Connectors | 0.006 Ω |
| Two cells connected in parallel | 0.002 Ω |
| Total circuit impedance | 0.112 Ω |

Using this example with an effective circuit impedance of 0.112Ω, the condition that will create a maximum balancing current of 2.5 A (two and a half amps) may be a differential voltage between Vo and the cells of 0.280V, which is calculated by multiplying 2.5 A by One half of this voltage (0.140V) may appear across each loop 510, 511.

For example, if V_{T} 540 has a value of 7.4V (3.7 volts for each cell), the Vo output voltage that will result in a balancing current of +2.5 A will be 3.840V (by adding 3.7V and 0.140V). This output voltage may correspond to a duty cycle of approximately 0.5189 (by dividing 3.840V by 7.4V).

The Vo output voltage that will result in a balancing current of −2.5 A will be 3.560V (by subtracting 3.7V minus 0.140V). This output voltage may correspond to a duty cycle of approximately 0.4811 (by dividing 3.560V by 7.4V).

Therefore, in this example, setting duty cycle limits to a maximum of 0.5189 on the high side and a minimum of 0.4811 on the low side may effectively limit the balancing current between +2.5 A and −2.5 A

Further, note that the calculations described in reference to this example may be applicable to a battery consisting of two cells in series. But if the battery has more than two cells in series, there will be additional current loops that are associated with SMDs that may be above or below the respective SMD under consideration. Current flowing through these adjacent loops will affect the current flowing in the balancing leg of the respective balancing loop under consideration.

Thus, in a battery with more than two cells in series, the balancing loop under consideration may need to be isolated from any cell balancing loops that are above or below it in the battery in order to characterize the impedance of the loop under consideration. This may be done by disabling (e.g., turning off the switches in) the SMDs above and below the SMD of the loop under consideration to isolate the loop under consideration. Accordingly, characterization of the limits of PWM duty cycle values in a battery with more than two cells in series may be achieved by disabling the adjacent SMDs above and below the SMD under consideration (e.g., by turning off the adjacent SMDs completely and/or turning off their switches). This makes impedance very high in the adjacent control loops, which makes the adjacent control loops have negligible impact on the current flowing around the SMD-Cell Loop under consideration.

For example, and referring to FIG. 5A, to evaluate the PWM limits for setting Vo23 at SMD-23 523, the first step may be to disable SMD 12 512 and SMD 34 534. This may effectively disconnect V12− from Vo23 and effectively disconnect V34+ from Vo23. Then the calculations described above can be performed to establish the PWM values which will limit the current flowing in the respective balancing leg connected to Vo23.

Accordingly, the foregoing process of disabling SMDs above and below a subject SMD for setting the duty cycle limits of a subject SMD can be performed on any balancing loop that is associated with any subject SMD in the battery pack. For the SMD that is at the highest voltage position in the pack, it may only be necessary to disable the SMD immediately below it. And for the SMD that is at the lowest voltage position in the pack, it may only be necessary to disable the SMD immediately above it.

Further describing temperature correction as referenced above: The impedances of the SMD components (e.g., two transistors, one inductor, two capacitors, and connections), copper wire and connectors can vary with temperature. So that variations in impedance due to temperature fluctuations may be accounted for, note the following.

In many example embodiments, the impedance values of the system 18 may primarily be a function of copper conductors and semiconductor switch ON resistance, both of which may have a positive temperature coefficient. Therefore, the impedance values described above may decrease as the temperature decreases. Additionally, the cells may have a negative temperature coefficient which may at least partially offset the positive temperature coefficient of other elements of the circuit. The offsetting negative temperature coefficient of the cells may be relatively slight as battery cell impedance is typically a lower value than the impedance of components in the loop connected to the cell itself.

Thus, a balancing current limit value derived using the ILCS method above may be temperature dependent. Accuracy may be improved if temperature compensation of the impedance variation is employed. Temperature may be measured at the electronics and at the cells using temperature sensors. Since the impedance values of the balancing electronics may dominate over the impedance values of the battery cells, an overall positive temperature coefficient of the complete circuit (including the cells) may exist. Using impedance values that are associated with the lowest manufacturer-rated or manufacturer-specified operating temperature of the system may ensure that the balancing current is always less than the first threshold current magnitude since the current will tend to decrease as the temperature increases.

Contrasting the ILCS method as described above versus use of hardware current sensors (e.g., per FIG. 2A), note that the total cost of a system using the ILCS method may be less than the cost of a system using hardware current sensors, since current sensors may be omitted from the balancing circuit when using the ILCS method. However, the ILCS method estimates balancing current in lieu of using current sensors and in some example instances may be less accurate than using hardware current sensors. Thus, relative to using hardware current sensors, the ILCS method in at least some instances may have a larger error term associated with the resulting balancing current value and therefore may be compared to the second threshold current magnitude value mentioned above to provide a greater safety buffer to prevent overcurrent conditions. For example, if the ILCS method has an inherent error of ±20% for a given system, and if the maximum balancing current that the system can tolerate is 3 Amperes (the first threshold current magnitude described above), then the second threshold magnitude current may be set at 2.5 Amperes (positive or negative) or even less to assure that the actual balancing current (as opposed to the estimate of balancing current) does not exceed the 3-Ampere threshold.

Thus, the second threshold current magnitude value may be limited so as to stay safely away from and not exceed the design capabilities of the balancing hardware. The calculated (or estimated) magnitude of Vo when using ILCS may therefore be less precise than if current sensors are used, so the second threshold current magnitude value may be set such that the value of Vo yields a balancing leg current that is consistently restricted from exceeding the first threshold current magnitude value which could compromise the reliability or safety of the balancing system hardware.

Accordingly, the ILCS method of sensing balancing current can provide cost savings by eliminating the hardware current sensors 218 from the system, with possible reduced accuracy in some examples in the estimation of balancing current and with possible reduced accuracy in some examples in the estimation of cell characteristics (which may include cell impedance and cell state of health (SOH)). In general, the greater accuracy of characterizing cell impedance that is afforded by hardware current sensors may enable more accurate characterization or estimation of cell characteristics such as state of health (SOH) in at least some examples.

In example embodiments where hardware current sensors are not used and the ILCS method is employed as a method of sensing balancing current, it may be useful to occasionally recalibrate the total loop impedance for the respective loop. Recalibration may involve periodic application of reference currents on the primary charge path to the complete string of cells in series when the battery is otherwise unloaded (e.g., not being used to power other systems external to the battery pack itself, such as a computer or vehicle) and when the battery is not being charged. The periodic application of reference currents for recalibration may be based on a recurring period of time recommended by the battery's manufacturer, such as every hour, every day, every week, every year, or after a specified number of charge cycles (e.g., every five cycles or every few hundred cycles).

The reference currents can be switched on at two or more known levels. For example, an initial reference current can be applied at 100% of the first current magnitude threshold and then a subsequent reference current can be applied at 50% of the first current magnitude threshold. Measuring the resulting cell voltages at the two or more reference currents using voltage sensors 210 may therefore be used to estimate effective impedance of the cells at any given time. Taking these measurements thus provides an updated estimate of the effective impedance of the cells for use in the ILCS mathematical model. The parameters of the Vo transfer function can thus be updated to compensate or correct for variations in cell impedance characteristics that occur over time and use of the battery.

For example, in a balancing system where 3 A establishes the first current magnitude threshold, the 100% reference level current (3.000 amperes) might produce a cell voltage of 3.850V depending upon the state of charge (SOC) of the cell. A 50% reference current (1.500 amperes) applied to the same impedance loop might produce a cell voltage of 3.843V. Subtracting 3.850V minus 3.843V yields a difference of 7 mV. In this example, the change in current of 1.5 A (3.0 A minus 1.5 A) may produce a differential voltage of 7 mV. Using Ohm's Law (7 mV/1.5 A), these measurements indicate a cell effective impedance of 4.67 mΩ. Using this reference current method, the effective impedance of the individual cells can be measured and then added to or subtracted from the total loop impedance of the Vo balancing leg and cell circuits.

The present application also recognizes that battery cell impedance may change over time such that cell impedance may increase as the cell continues to age. Using hardware current sensors, recalibration in response to changes in cell impedance may not be required since, in using hardware current sensors, any change in cell impedance can be characterized directly using the current sensors 218.

To reiterate, note that calibration of cell impedance may not be needed if the battery has and employs the hardware current sensors described above. Calibration (or recalibration) can optionally be performed when employing the ILCS method for balancing leg current sensing and limiting.

In practice, recalibration may in some instances only be desirable to maintain the highest balancing leg current that is possible as cell impedance increases with age while providing a suitable safety buffer between second current magnitude threshold and the first current magnitude threshold. As cell impedance increases with age, current for cell balancing will correspondingly decrease over time, thus maintaining the limited maximum balancing leg current below the first current magnitude threshold in embodiments that employ ILCS without calibration. Thus, while employing ILCS, calibration or recalibration may not be needed to maintain safety, but it can be employed to increase the balancing leg current as the cells degrade. Without recalibration, ILCS may still be used and be effective at estimating balancing leg current but may in some instances keep balancing leg current at less than possible values as time goes on.

The above methods may be implemented as software instructions executed by a controller 220 such as a processor, a suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

### Benefits of One or More Embodiments

The battery management system disclosed herein enables significant improvements in the performance and function of batteries; in particular, batteries with low internal impedance such as lithium-ion batteries. Key areas of improved performance of one or more embodiments of the invention are described herein for context of the benefits the technology may provide.

Aspects of the invention complete the equivalent of a CCCV charge cycle on every cell in the battery, regardless of age of the battery and regardless of variations in cell characteristics (such as capacity, SOC and self-discharge rate). Cell characteristics inevitably drift and vary over time and use. These variations in characteristics can grow quite wide in batteries that experience frequent use, such as in electric vehicles, and can make it difficult to balance the battery.

Prior balancing technologies have limited balancing performance and may take many hours or even several days to balance a battery with wide variations in cell characteristics. The most commonly used balancing technology (passive balancing) tries to balance the battery by draining energy out of cells and diverting the energy to load resistors where it is converted to heat, which adds stress to the battery and to system electronics. This form of balancing may be considered 100% inefficient, because 100% of the balancing energy is removed from the battery. And this form of balancing is necessarily slow; the balancing current must be limited (typically to 100 mA to 200 mA) to limit the amount of heat that is generated.

In contrast, one or more embodiments of the invention set forth herein can balance batteries quickly and efficiently. This is achieved by moving energy from the primary charge path (or from higher SOC cells) to lower SOC cells. The efficiency of each balancing loop is typically greater than 95%, which means that very little of the balancing energy is dissipated as heat. This enables much greater balancing currents. In a typical battery in an electric vehicle, for example, balancing current can be between 2 A and 5 A. This is between 10 and 50 times greater than the balancing current in a typical passive balancing system. This allows the present invention to complete charging and balancing cycles between 10 and 50 times more quickly than passive balancing.

Additionally, one or more embodiments of the invention can balance during discharge. This allows energy to be moved from higher SOC cells to lower SOC cells during discharge, which enables more complete utilization of the energy stored in the battery. Passive balancing systems cannot balance during discharge, so when the weakest cell reaches the low voltage cut-off, the battery must be disconnected from the load and must be recharged before it can be used again. But when the weakest cell reaches cut-off voltage, every other cell in the battery still has energy that could be used—except for the fact that passive balancing systems have no way to access that energy. By balancing during discharge, one or more embodiments of the invention can access most of that additional energy in the battery which can, for example, significantly extend the driving range of an electric vehicle.

An additional performance benefit embodiments of the invention provide is maximization of battery life. As batteries age and cell characteristics drift, the battery eventually will get out of balance to a point that current passive balancing systems cannot bring the battery back into balance. When that happens, the battery quickly accelerates into increasingly out-of-balance conditions, which shortens the life of the battery. One or more embodiments of the invention eliminates out-of-balance conditions for the entire life of the battery, regardless of variations in cell conditions. This can extend battery life by an estimated 20% to 30% in tier-1 batteries, and by as much as 100% in tier-2 batteries.

Another benefit one or more embodiments of the invention provide is that it enables measurement of impedance on a cell-by-cell basis while the battery is installed in a product (such as an electric vehicle) and while the battery is charging, discharging or idle. One or more embodiments of the invention enable measurement of DC resistance and AC impedance at frequencies that typically range from 1 Hz up to 10 kHz (or more), and one or more embodiments of the invention enable measurement of static impedance and dynamic impedance (the first derivative of static impedance). Having the ability to measure these forms of impedance provides insight into the health and aging of the cells in the battery. Existing (or prior) balancing technology is not able to measure all of these forms of impedance on a cell-by-cell basis.

These features of one or more embodiments of the invention provide benefits to many industries that work with or use batteries. As examples, two industries that would benefit from one or more embodiments of the invention are manufacturers of electric vehicles and manufacturers of the batteries that go into electric vehicles.

Benefits to Electric Vehicles

By integrating one or more embodiments of the invention into electric vehicles, manufacturers of the vehicles would enjoy benefits such as an ability to have longer vehicle range, because more energy is stored in the battery during charge, and more of that stored energy can be delivered to the vehicle's motor(s) while the vehicle is being driven. Electric vehicles could also decrease the loss of driving range over the life of the vehicle, because loss of range due to out-of-balance conditions is reduced. Vehicles implementing one or more embodiments of the invention would have an increase in the life of the vehicle, because battery life is increased. The system is also able to provide early warnings to the driver of cells that are going bad. This can be the difference between a preventive maintenance procedure and the driver being stranded on the side of the road with a bad battery.

Benefits to Battery Manufactures

By integrating one or more embodiments of the invention into their batteries, battery manufacturers would enjoy having a technology where cells don't need to be so closely matched when batteries are assembled, because one or more embodiments of the invention compensate for variations in cell characteristics. This can lower manufacturing costs and reduce manufacturing scrap rates. One or more embodiments of the invention enable a manufacturer's tier-2 batteries to perform similarly to present tier-1 batteries that use passive balancing. Similarly, tier-3 batteries using one or more embodiments of the invention can perform similarly to tier-2 batteries that have passive balancing. Additionally, batteries will have a greater average capacity over the life of the battery. One or more embodiments of the invention increases the average lifetime capacity of the battery. Phrased another way, simply by removing passive balancing from a battery and installing one or more embodiments of invention, the battery becomes bigger (in terms of available capacity).

Another benefit is that battery manufacturers will be able to get real-time data on cell impedance from batteries that are in the field, being used in real-world conditions. Prior to one or more embodiments of the invention discussed herein, getting real-time data on cell impedance has not been possible. The ability of one or more embodiments of the invention to obtain data on cell impedance provides valuable data on how cells age and decay in real-world use environment, which in turn will allow battery manufactures to detect defects, improve production processes and develop improved battery technologies.

Now specifically referring to FIG. 1, an example system 10 is shown, which may include one or more of the example devices mentioned above and described further below in accordance with present principles. The first of the example devices included in the system 10 is a device 11, such as a consumer electronics (CE) device, e.g., a tablet computer, a notebook computer, a wearable computerized device, a computerized Internet-enabled bracelet, other computerized Internet-enabled devices, a computerized Internet-enabled music player, computerized Internet-enabled headphones, a computerized Internet-enabled implantable device such as an implantable skin device, etc. Other example devices 11 include energy storage modules (such as battery arrays) in electric vehicles, industrial power systems, and storage devices used in power grid or structure electrical systems.

The device 11 may be powered by a rechargeable battery 14, such as a Lithium-ion battery with plural cells 16 connected together in electrical series with each other, it being understood that while only a single connection is shown between the battery 14 and device 11, more than one electrical line typically connects the battery to the device. The battery 14 may be removably or non-removably coupled to the housing of the device 11. A Lithium-ion battery may be implemented by any battery that uses lithium, including batteries that use cathodes with chemistries such as Lithium Iron Phosphate, Lithium Cobalt Oxide, Lithium Nickel Manganese Cobalt Oxide, Lithium Manganese Oxide, Lithium Nickel Cobalt Aluminum Oxide, Lithium Titanate, or any other battery chemistry that uses lithium ions. While present principles envision, in example embodiments, use in connection with Li-ion batteries, present principles contemplate use with any appropriate stored energy source or storage element, in particular (though not exclusively) those that exhibit a low impedance characteristic during charge/discharge.

As discussed further below, a balancing system 18 can be electrically connected to the battery 14 while charging or discharging the battery 14. The balancing system 18 can be incorporated all or in part within the housing of the device 11 or it may be separate therefrom. The balancing system 18 can be enclosed inside the battery case or it can be disposed outside the battery case.

Among the components of the balancing system 18 that are more fully disclosed below are at least one controller 20 and at least one data storage medium 22. If desired, the balancing system 18 may also include one or more displays 24 such as a liquid crystal display (LCD) and one or more input devices 26 such as a network interface, universal serial bus (USB) port, key entry device, etc. A network interface may provide for communication over one or more networks such as the Internet, a wide area or local area network, a Wi-Fi network, a wireless telephony network, a Bluetooth network, etc.

The data memory 22 may be, without limitation, disk-based or solid-state storage that is not a transitory signal. The memory may be removable media.

In any case, as discussed further below, the balancing system 18 acts to equalize the voltages of the individual cells 16 during charging from a charging power source 28.

Turning now to FIG. 2 for a more detailed depiction of an example balancing system 18, the balancing system 18 includes plural switch mode dividers (SMDs) 200. As understood herein, a balancing system that uses SMDs 200 can overcome limitations of less efficient balancing systems. The low impedance current paths of the switch mode design provide higher efficiency at moving energy to balance cells in the battery as compared to balancing technologies which do not employ switch mode dividers. But the low impedance of the switch mode design results in a control system with high loop gain, rendering the control loop very sensitive to even the most modest differences in voltages of the cells 16. Current sensors 218 in the below-described balancing legs 212 of the balancing system 18 are used to determine whether the current in the balancing legs 212 is within the threshold range that is specified by the below-described threshold(s) for the balancing system 18. This current measurement enables the balancing system 18 to limit the loop gain of the circuit, resulting in more effective control of the high-gain loop.

In general, and prior to describing the details of the balancing system 18, the SMDs 200 are high power (low impedance) voltage dividers. The control output voltage Vo is a function of the duty cycle of the drive waveform and of the high and low rail voltages (V+ and V−) of the respective SMD 200.

In accordance with switch-mode circuit techniques, each SMD 200 is driven by a constant period signal having a unique ON time and OFF time, the sum of which two times is essentially always equal to the total constant period. SMD modulation takes the form of Pulse Width Modulation (PWM) in that the ratio of ON time to total period (also defined as duty cycle) is adjusted to vary the control output voltage Vo in direct correspondence.

If the duty cycle is 50%, the output voltage will be at the midpoint between the high rail voltage and the low rail voltage. The low impedance of the SMD-based balancing system 18 allows relatively large balancing current levels to be applied to the cells 16 at very high efficiency. Because both the SMD 200 and the Li-ion cell 16 are very low impedance devices which are essentially connected in parallel, a very small change in the duty cycle, creating a small voltage difference, produces a relatively high corresponding level of differential balancing leg current. When changing the voltage that is applied to low impedance cells to charge and/or balance them, the resulting high-gain response can create feedback instability for the balancing system, a problem that is addressed by use of the below-described current sensors 218 in the balancing legs 212.

Accordingly, and turning to the details of FIG. 2, plural battery cells 16, in the example shown four cells, are arranged in electrical series with each other as shown to define a primary charge/discharge path 202. The series of cells comprises a battery that has a positive terminal 222 and a negative terminal 223. The balancing circuit 18 is arranged in electrical parallel with the primary charge/discharge path 202 as shown.

The balancing circuit 18 includes a voltage sensor line 204 in parallel with the primary charge/discharge path 202. The voltage sensor line 204 includes a positive node 206 to which the “high” or positive side of the first SMD 200 (the top-most labeled V+ in FIG. 2) is electrically coupled and a negative node 207 to which the “low” or negative side of the last SMD 200 (the bottom-most labeled V− in FIG. 2) is electrically coupled. The control output Vo of each SMD 200 is connected to a respective balancing leg 212 that includes a respective current sensor 218 and terminates at a respective cell junction 208 between adjacent cells 16 as shown. Note that in example embodiments a total of N-1 SMDs 200 are provided for N cells 16. Note further that in order from top to bottom, the negative side (V−) of the top-most SMD 200 is connected to the control output voltage Vo of the next (middle, in the example shown) SMD 200, while the positive side V+ of the middle SMD 200 is connected to the control output voltage Vo of the top-most SMD, with this pattern repeated in all of the SMDs as shown.

In other words, the positive rail (V+) of each SMD 200 is connected to the balancing leg 212 that is next highest in the series or is connected to the positive node 206 and to positive terminal 222 if there is no higher balancing leg in the series. The negative rail (V−) of each SMD 200 is connected to the balancing leg 212 that is next lowest in the series or is connected to the negative node 207 and negative terminal 223 if there is no lower balancing leg in the series. The control output voltage Vo of each SMD 200 is connected to the balancing leg 212, which passes through the current sensor to the respective cell junction 208.

A respective voltage sensor 210 is in the voltage sensor line 204 in electrical parallel with a respective cell 16 to generate a signal representative of voltage across the respective cell 16. The voltage sensors 210 are communicatively coupled to the controller 220 as described further below, so that the controller 220 receives voltage information from the respective voltage sensor 210.

The control output voltage Vo of each SMD 200 is connected via a respective balancing leg 212 to the respective cell junction 208. The balancing legs 212, in some examples, consist of the electrical circuit shown between the nodes shown connecting Vo to the respective cell junctions 208. A respective current sensor 218 is electrically connected to the balancing legs 212 in electrical series between the control output voltage Vo from each SMD 200 and the respective cell junction 208 to generate a signal representative of current through the respective balancing leg 212. Note that the current sensor 218 shown in FIG. 2 in the top-most positive line that includes the positive node 206 is optional. Each current sensor 218 is communicatively coupled to the controller 220 discussed below so that the controller receives balancing leg current information from the current sensors 218.

Accordingly, at least one controller 220, preferably a digital microcontroller, is connected to the SMDs 200 to modulate the SMDs 200 to establish the control output voltage Vo of each SMD 200 that adds to or subtracts from the voltage on the primary charge path 202 for the respective cell 16 to maintain current on the balancing legs 212 within certain limits as explained further below.

In establishing the control output voltage Vo, the duty cycle of the SMD 200 is increased to raise the output voltage and decreased to lower it as discussed above and further explained below.

FIG. 3 illustrates the operation of the balancing system 18 shown in FIG. 2. The process begins at start state 300. Battery charge is commenced at block 302 on a battery 14 with each cell 16 at any SOC and with the cells 16 in any condition of balance or out-of-balance, typically below Full Charge Voltage. Block 304 indicates that charging is commenced by applying charge current, flowing from the positive to negative terminals on the primary charge/discharge path 202. The magnitude of the current on the primary charge/discharge path 202 may typically be greater than the magnitude of the balancing current on the balancing legs 212.

The voltage of each cell 16 is monitored using the respective voltage sensors 210, and when it is determined at decision diamond 306 that at least one cell 16 reaches or exceeds Full Charge Voltage (FCV), the logic proceeds to block 308 to modulate the SMDs 200 to equalize the cell voltages. That is, in example implementations, the cell equalization with current-limiting operation discussed below starts only when the first cell reaches FCV. In other embodiments input from the current sensors is used by the controller to limit current through the balancing legs to be no more than a threshold current magnitude before at least one cell reaches full charge voltage during battery charge.

Should a cell 16 reach a voltage above full charge voltage as indicated by the respective voltage sensor 210 of the cell 16, the controller 220 lowers the voltage of the cell 16 by modulating the SMD 200 that is associated with the over-voltage cell 16 to reduce the cell's voltage at a controlled rate until the voltage is at or just below FCV.

As the SMDs 200 are being used to alter the cell voltages, the logic determines at decision diamond 310 whether the magnitude of the current (positive or negative) as measured by any balancing leg current sensor 218 is at or beyond a threshold value, typically a maximum allowed current magnitude. This applies to limiting both negative and positive current, because balancing current can flow in either direction. Note that one threshold may be used for negative current and another, different threshold may be used for positive current, or a single threshold may apply to both. Should the magnitude of any balancing leg current satisfy the threshold, e.g., by being at or beyond the threshold at decision diamond 310, for instance as a result of having applied modulation of block 308 at an excessive rate of change, the logic moves to block 312 to modulate the SMDs 200 to adjust the voltages of adjacent cells 16 to bring the balancing leg current magnitude at or below the threshold.

In other words, if at any time during the balancing process, the control of the output voltages Vo to equalize the cell voltages are adjusted in a manner that results in the magnitude of the current in any balancing leg 212 to be at or beyond the limit threshold, then the modulation of an SMD 200 that is at and/or adjacent to the balancing leg 212 with excessive current is adjusted to reduce the voltage differential between the cell 16 with excessive balancing current and one or both adjacent cells 16.

The controller 220 preferably establishes as much of the allowed magnitude of balancing current as possible, albeit always below the maximum permitted threshold, to provide for the fastest charging and balancing without violating the threshold for balancing leg current magnitude. Thus, in example embodiments the balancing current magnitude is maintained at a high level at or below a threshold to prevent overcurrent conditions that could damage the system 16 or pose a safety hazard.

The above monitoring of voltage and current data and SMD modulation continues preferably until at least one and more preferably two conditions are met. As indicated at decision diamond 314 it is determined whether all cells 16 have reached FCV. If not, the process loops back to block 308. If all cells have reached FCV, the logic can move from decision diamond 314 to decision diamond 315 to determine whether the current to each cell has decreased to a level indicative of the battery 14 having reached True Battery Capacity. If so, the process ends at state 316. Otherwise, the logic loops back to block 308.

In modulating the SMDs 200, if the controller 220 determines, based on the signal from a balancing leg current sensor 218, that the current flowing in the balancing leg 212 is too high (e.g., above the threshold) in the positive direction (from the SMD 200 into the respective cells 16) then the duty cycle of the SMD 200 is reduced to lower its control output voltage Vo. On the other hand, if the current in the balancing leg 212 is too great in the negative direction then the controller modulates SMD 200 to increase its duty cycle and thus raise its control output voltage Vo.

Note that the controller 220 samples all cell voltages as indicated by the voltage sensors 210 for ongoing modulation of the SMDs 200 to equalize cell voltages while maintaining balancing leg current magnitudes at or below the threshold for balancing currents. When SMD 200 control output voltage Vo at any one cell 16 is altered, it will affect the adjacent cells 16 and adjacent balancing leg currents because the cells 16 are connected in series, so modulation and adjustment of the output voltages of the SMDs 200 is typically an ongoing process while the balancing system 18 is operating.

If desired, the threshold magnitude for the balancing leg current may be established as a function of battery capacity, chemistry of the battery, design of the battery, and use environment. In general, the threshold magnitude of the balancing leg current is selected to be a suitable percentage of the maximum permissible charging current based on the design objectives of the battery system. A higher balancing current threshold allows the cells 16 to reach a balanced state in a shorter time, but a too-high threshold can lead to cell or system damage, so the threshold is established to ensure current in the balancing leg 212 remains below the cell or system stress level.

As an example, in larger batteries a balancing current range threshold of 5% to 10% of the maximum primary charge current is typically sufficient to ensure 100% balancing within an hour or two under conditions of the battery 14 and cells 16 that would typically occur. The closer the SOCs of the cells 16 are to each other, the lower the balancing range required to achieve complete balance over any given time period. Some designers may opt for a lower range of 2% to 3%, for example, to save cost; while others may opt for a higher range (20% or 30% of maximum primary charge current, for example) if faster balancing times are more important than system cost.

It may now be appreciated that currents on the balancing legs 212 can be advantageously used as proxies for the charge current to each cell 16 in the primary charge path 202. As understood herein, current in the balancing legs 212 correlates closely enough to the main charging current on the primary charge path 202 that it can be used to determine when each cell 16 has reached 100% SOC. This allows the current sensors 218 to be placed on the balancing legs 212 and allows use of current sensors 218 with much lower current rating than would be needed to sense current on the primary charge path 202. The use of two inputs—current on the balancing legs 212, and voltage on each cell 16—enables very high efficiency (from the switch mode circuit) and very good stability (from the addition of the current sensors 218). Moreover, the circuit 18 can reliably, efficiently, and accurately bring every cell 16 in the battery 14 up to 100% SOC at the end of every complete charge cycle. In other words, by monitoring cell voltage and balancing leg current, the controller 220 can detect when cells 16 reach Full Charge Voltage and then subsequently reach 100% SOC. When a cell 16 first reaches Full Charge Voltage, it is usually not yet at 100% SOC, so additional charging is typically required after Full Charge Voltage to bring the cell up to 100% SOC, which is made possible by the balancing leg current sensor 218 input, which enables accurate, reliable determination of when a cell 16 has reached 100% SOC. An indication of 100% SOC occurs when a cell 16 is at Full Charge Voltage as indicated by the respective voltage sensor 210 and current to the cell 16 as indicated by the current sensor 218 associated with the cell 16 has dropped to a very low level, typically around 0.05 C to as low as 0.01 C, wherein “C” is a measure of current rate relative to a capacity of the cell.

Furthermore, locating the current sensors 218 on the balancing legs 212 avoids compromising the battery's primary charge path 202.

In addition to enabling management of the inherent differences in voltage drop among the various cells 16, using the balancing current as an input to the feedback loop used by the controller 220 mitigates the instability disadvantage of the low impedance SMD 200 configuration while maintaining all the added advantages of that configuration. Using the current sensors 218, cell voltages need only be approximately measured, while limiting the current in the balancing legs 212 to a finite maximum level effectively eliminates potential loss of control of a high-gain charging system.

Still further, current and voltage sensors of relatively low accuracy (typical accuracy of 2% of maximum cell voltage for the voltage sensors 210 and 0.03 C for the current sensors 218) are sufficient because the accuracy (or resolution) of voltage and current measurement only needs to be great enough to detect possible runaway current conditions and make corrections to prevent them, and to ensure that cells 16 do not rise above Full Charge Voltage and/or do not approach Maximum Cell Voltage (the maximum voltage a cell can be charged to without incurring risk of damage to the cell.)

Also, current sensors 218 on the balancing legs 212 can be rated to be relatively small and inexpensive as compared to current sensors that might be placed in the primary charge path 202; the current sensors 218 on the balancing legs 212 do not siphon off energy from primary charge path 202, which would reduce the efficiency of the system; and unlike larger current sensors on the primary charge path, balancing leg current sensors do not generate undue heat.

Because high charge current can be efficiently and safely applied throughout the charge cycle, with charge current dropping to a low level as any cell 16 reaches Full Charge Voltage, faster charge cycles than currently are provided are realized by the circuit 18. Furthermore, the balancing circuit 18 can balance cells 16 that are significantly out of balance. As long as no cell 16 is defective (essentially, as long as all cells can be charged), the balancing circuit 18 can bring every cell 16 in the battery 14 up to 100% SOC and into balance with all of the other cells 16 in the battery 14, regardless of the SOC of each cell 16 at the start of the charge cycle.

Variations in cell characteristics do not affect the balancing performance of the balancing circuit 18. In other words, the balancing circuit 18 can fully charge and balance a battery regardless of variations in cell characteristics.

The SMDs 200 are modulated by the controller 220 to independently regulate the balancing current to each cell 16 until each cell 16 reaches Full Charge Voltage and high impedance, at which point each cell 16 has reached 100% SOC. In non-limiting embodiments, this can be accomplished while minimizing stress on the cells by modulating the SMDs 200 to establish cell voltages that will bring low voltage cells 16 up rather than bringing high voltage cells 16 down, minimizing current shunting between cells 16. In general, but without limitation, cells 16 can be brought from a discharged state up to a fully charged state in a steady upward charge cycle, with very little or no discharges from individual cells 16 as part of the balancing scheme during charging.

In addition to the advantages noted above, the present balancing circuit 18 eliminates the need to discharge cells 16 through load resistors to maintain balance and overcomes limitations on balancing range that are inherent in some systems. The present balancing circuit 18 enables use of current sensors 218 rated for only a small fraction of the ampacity of the battery, which reduces cost of the current sensing system. The full main charge current can be applied for most of the charging cycle with the balancing circuit 18 preferably switching on only when at least one cell 16 reaches Full Charge Voltage. At this point the other cells 16 have also been charged for some time and will typically be close to Full Charge Voltage. Accordingly, in example embodiments the cell balancing is performed by the instant balancing circuit 18 only near the end of each charge cycle when all of the cells 16 are near Full Charge Voltage and only a small amount of balancing current is needed to quickly balance the cells 16 and bring all of them to 100% SOC.

While the above-described balancing process contemplates cell equalization during battery charge, the same principles also may be used during battery discharge. In an embodiment, the logic in controller 220 balances the cells 16 in the battery 14 during a discharge cycle (typically when the battery 14 is powering a load). The logic that equalizes cell voltages while limiting the current on the balancing legs 212 thus may be employed during discharge cycles as well as during charge cycles.

As understood herein, balancing during discharge cycles can increase the available capacity of the battery 14. If there is a significant difference in capacities of cells 16 in the battery 14 (for example, if the smallest cell has a capacity of 90% or less of the largest cell), a management system that is typically provided for a battery will electrically disconnect the battery from the load when the smallest cell has reached a minimum cell voltage. On the other hand, if a battery is balanced during discharge, stored energy in higher voltage (or higher SOC) cells will be transferred to cells with lower voltage (or lower SOC), thereby increasing available battery capacity.

With the present balancing circuit 18, there is no need to collect, store and analyze data on battery charge and discharge cycles to try to mitigate inherent inaccuracies in estimating SOC.

Next a method for approximation or estimation of an effective balancing leg current will be described in example embodiments where a balancing system as described herein does not include hardware current sensors on balancing legs as described above. Thus, it is to be understood consistent with present principles that in lieu of a specific hardware current sensor that physically senses current through a balancing leg, estimations of current along balancing legs may also be used consistent with present principles. Without limitation, estimating balancing current as described below may be referred to as impedance limited current sensing (ILCS) below.

FIG. 4 again illustrates the balancing circuit 18 but with the current sensors 218 excluded from the circuit 18. As shown in FIG. 4, various balancing loops including balancing loops 400 and 402 may include a respective SMD 200 of the circuit 18 that may be characterized by an SMD output Vo along a corresponding balancing leg 212. As may also be appreciated from FIG. 4, each loop may also include two adjacent cells 16 arranged in series along the primary charge/discharge path 202 and a respective positive rail (V+) and a respective negative rail (V−) of the respective SMD 200. As shown in FIG. 4, the example loops 400, 402 may share a respective SMD Vo output as well as the two adjacent cells 16 and the loops 400, 402 may thus include a relatively low-impedance circuit path having two or more voltage sources connected in parallel. If the parallel voltages are exactly equal, then zero current will flow in the respective loop. Thus, Ohm's Law I=E/R (with “E” being voltage in this case) where E=0 will result in a current I=0 for all non-zero values of R (resistance). When the balancing system is operating, the voltage Vo for the respective SMD 200 may be adjusted in accordance with the algorithm of FIG. 3 to cause a corresponding balancing current to flow in the balancing leg circuit path. The current flowing in the respective balancing leg 212 and thus the resultant balancing current that is applied to the respective cells may be limited to a threshold level at or below the design limit of the system as described above in FIG. 3 as the threshold current, thereby preventing excessive current that can stress and/or damage the system.

Thus, an ILCS system as reflected in FIG. 4 (where there are no hardware current sensors) may be used where the controller 220 calculates an approximation of the current on the respective balancing leg 212. It may do so by characterizing the impedance of the respective loop, estimating the voltage Vo on the respective balancing leg 212 as controlled by the respective SMD 200, and receiving data from the respective voltage sensor 210 of the respective loop that is adjacent to the respective cells 16. With these numbers, the controller 220 may estimate (using Ohm's Law) the current flowing in the respective balancing leg 212 without the use of a hardware current sensor 218 to perform a direct measurement of the actual balancing leg current.

In addition to the loops 400, 402, other loops are also shown in FIG. 4 including loops 406 and 408. Each of the loops 400, 402, 406, 408 may include instances of balancing leg current(s) and SMD output(s) Vo. In non-limiting examples, the current flowing in any given balancing leg may be the algebraic sum of the currents flowing in all of the various loops, which include the respective balancing leg or legs, one or more corresponding SMD outputs Vo, and one or more corresponding battery cells. The application of Thevenin's Theorem allows the reduction of the balancing leg current to a simplified function proportional to the Vo voltage on the respective balancing leg 212 and the combined (Thevenin equivalent) loop impedance of the associated current paths and the impedance of the cell(s) 16 as shown in FIG. 4.

In non-limiting practical applications, each SMD may be connected to multiple cells using conductive paths of copper wire, connectors, and copper printed circuit board (PCB) traces. However, note that other suitable materials besides copper may also be used. Regardless, the Vo voltage of the various SMD outputs may still be adjusted by the controller 220 using the algorithm of FIG. 3 but note that the specific value at which any Vo should be set using the algorithm of FIG. 3 can be estimated even without input from a current sensor indicating a respective current in a respective balancing leg because the value of Vo is a direct function of the duty cycle of the corresponding SMD (as modulated by the controller 220) and its associated voltages V+ and V− (which may be measured by the respective voltage sensor(s) 210 in the respective loop). Employing ILCS, the impedance of all elements in the loop (including cell impedance) may be characterized and the value of Vo can be approximated for calculating an estimate of the respective balancing leg current.

The characteristic impedance of the Vo output for each SMD may be a function of the total loop impedance of the respective SMD circuit. Items that contribute to Vo output impedance may include the SMD switches (such as field-effect transistors (FETs) and/or comparable bipolar transistors), the filter inductor impedance of the SMD and the filter capacitor impedance of the SMD, and the various circuit board traces that connect these circuit elements to the Vo output electrode.

As a practical consideration, the impedances of loops such as 400, 402, 406 and 408 may be a known constant that can be determined when the system is designed or empirically at the time of manufacture, as the impedances of the loops are a function of the circuit connections that include components and conductive paths inside the SMD as well as wires, connectors and any other conductive paths between the Vo output electrode and the battery cells themselves.

Note that the impedances of individual components in the loop and the copper wire and connectors can vary with temperature and therefore if variations in impedance due to temperature fluctuations should be accounted for in a given implementation, temperature fluctuations can be determined using temperature sensors within the circuit 18. The temperature sensors might be located, for example, at or adjacent to the battery cells themselves and/or somewhere along the printed circuit board (or other components) establishing the circuit 18 itself. Temperature coefficients for the various components and elements of the circuit 18 could be stored locally, for example in a look-up table or database, and these temperature coefficients could be applied to temperature measurements taken with the temperature sensors to calculate or estimate the loop impedances, corrected for the instant local temperature. The database or look-up table may be populated based on empirical determinations made by the battery manufacturer prior to vending. Alternatively, a temperature/impedance coefficient can be calculated or estimated for the entire circuit 18 and this aggregate temperature coefficient can be applied to changes in temperature to estimate changes in impedance of the circuit 18.

To employ ILCS as a method of sensing current on the balancing legs, a basic transfer function from the PWM value of the respective SMD to the resulting balancing leg current can be established. This transfer function may be affected by multiple factors and as described herein may only need to be approximate to ensure that the high and low extents of the PWM duty cycle may be limited such that the range of resultant Vo values based on current estimation produce a balancing leg current at or below a desired threshold current magnitude. This threshold may be referred to below as a second threshold current magnitude that may be a predetermined amount less than the first threshold current magnitude described above (which is the maximum permitted threshold used to prevent overcurrent conditions). The second threshold current magnitude, which may be used in the ILCS method, may be set at a magnitude less than the first threshold current magnitude to safeguard against coming close to or exceeding the first threshold current magnitude.

For any given SMD in the circuit 18 as shown in FIG. 4, the circuit 18 can be reduced to three voltages, with those three voltages being Vo of the corresponding SMD and the voltages as measured by the voltage sensors 210 of the corresponding two cells connected to Vo. In accordance with Ohm's Law, the algebraic sum of these voltages when divided by the combined characteristic impedance of the respective loops containing those voltages may provide an approximation of the balancing leg current for the respective balancing leg.

Next, a numeric example of estimating Vo using ILCS will be provided in reference to a four-cell battery configuration as shown in FIG. 5. As may be appreciated from FIG. 5A, a balancing circuit 500 may be similar in many respects to the circuit 18 and include many of the same components arranged similarly as in the circuit 18, including a controller 502 and primary charge/discharge current path 504 for four cells arranged in series. This example shows how to estimate Vo23 as a function of the duty cycle applied to the SMD23 so as to maintain the balancing current within a range of ±2.5 A, which (in this example) may be the second threshold current magnitude referenced above.

Describing FIG. 5, the output Vo23 may be connected to the junction of two cells, labeled CELL2 and CELL3 in FIG. 5. The high and low electrodes (V23+ and V23−) of the SMD23 may be connected respectively to the positive terminal of CELL2 and negative terminal of CELL3.

The Control-23 input of the SMD23 may be a square wave signal. The PWM duty cycle of the square wave signal may be generated by the microcontroller 502.

In one example embodiment, the high time of the square wave control signal connects V23+ to Vo23 and the low time of the square wave control signal connects V23− to Vo23. An LC circuit/filter in series with these connections may produce a DC voltage at Vo23 with respect to V23− which is proportional to the duty cycle of the square wave control signal multiplied by the total voltage (V_{T}) of the two cells CELL2 and CELL3 in series. Note that V_{T} as shown in FIG. 5a shows where the voltage drop between the top of CELL2 and the bottom of CELL3 may be measured and is not an indication that there is a voltage sensor from the top of CELL2 to the bottom of CELL3 designated as “V_{T}”. Rather, V_{T} just illustrates where/how V_{T} may be measured in this example using the respective voltage sensors 210 connected in parallel to CELL2 and CELL3.

As an example, and referring to SMD 23 shown in FIG. 5, if V23+ is +20 volts and V23− is +12 volts, then V_{T} is (+20)−(+12)=+8 volts. Note that V+ may always be more positive than V− for each SMD in various example embodiments.

The duty cycle of the Control-23 square wave signal may be expressed as a scalar value between zero and one, as illustrated in the following three examples. First, a duty cycle of 1.00 may connect V23+ to Vo23 continuously. Second, a duty cycle of 0.00 may connect V23− to Vo23 continuously. Third, a duty cycle of 0.50 may connect V23+ and V23− to Vo23 alternately and for equal time periods.

Thus, a duty cycle of 0.50 may produce a symmetrical square wave which results in a value of Vo23 midway between V23+ and V23− for SMD 23, which may be expected behavior of an SMD.

Accordingly, when enabled, the respective SMD may generate a low impedance divided voltage, Vo, which may always be between V+ and V− according to the ratio of the duty cycle of the square wave control signal. Modulating the duty cycle of the control signal may therefore generate a voltage at Vo that ranges between V+ and V−, depending on the duty cycle of the modulation.

Note that a theoretically perfect circuit would have the following characteristics. First, both switches in the SMD would have zero impedance when on, and infinite impedance when off. Second, the filter inductor would have zero resistance. Third, the connections to the cells (wires and printed circuit board traces) would have zero resistance. Fourth, the respective battery cells would have zero impedance and equal voltages. With a theoretically perfect circuit, a control duty cycle of exactly 0.50 would result in a Vo value exactly equal to the voltage at the junction of the two battery cells. In this case, zero current would flow in the balancing leg because the circuit would be exactly balanced. (Note: In this context, “balanced” refers to the condition of the theoretically perfect circuit and not to the relative SOCs of the cells in the battery.) Thus, under these theoretical ideal conditions, any duty cycle other than 0.50 would imbalance the circuit and produce theoretically infinite current.

But in a real-world circuit, the aforementioned elements from the immediately preceding paragraph may have a finite nonzero resistance or impedance. As such, the duty cycle can be varied to produce an at least somewhat predictable, finite current on the balancing legs.

Two active cell balancing loops are highlighted in FIG. 5. A first cell balancing loop 510 may begin at V23+ of the SMD 23 and extend to the positive terminal of CELL2, across CELL2, to the negative terminal of CELL2, on to the SMD 23 electrode Vo23, across the SMD 23 positive side, and back to V23+ of SMD 23. As also shown in FIG. 5, a second cell balancing loop 512 may begin at V23− of SMD 23, extend to the negative terminal of CELL3, across CELL3 to the positive terminal of CELL3, on to the SMD 23 electrode Vo23, across the SMD 23 negative side and back to V23− of the SMD 23.

Currents flow in the same direction at the balancing leg around balancing loops 510 and 512, and so current flowing around balancing loops 510 and 512 will always be additive at the common balancing leg to create the total current in the balancing leg of SMD 23.

A numerical example will now be provided that uses impedance values that may be seen in a real-world circuit to illustrate how to calculate PWM duty cycles that would yield a maximum (absolute value) balancing current flowing in the balancing leg connected to Vo23 for the second threshold current magnitude referenced above when using the ILCS method. In this example, the second threshold current magnitude is ±2.5 A.

According to this example, assume each cell has an impedance of 0.004Ω. The two cell balancing loops 510, 512 of FIG. 5 may be connected in parallel, and so the parallel combination of cell impedance for this example is 0.002Ω.

The impedance values in the table below may be representative of materials at a temperature of 25° C.:

| | |
|---|---|
| SMD Vo output impedance | 0.083 Ω |
| PCB trace copper | 0.006 Ω |
| Cell wiring | 0.015 Ω |
| Connectors | 0.006 Ω |
| Two cells connected in parallel | 0.002 Ω |
| Total circuit impedance | 0.112 Ω |

Using this example with an effective circuit impedance of 0.112Ω, the condition that will create a maximum balancing current of 2.5 A (two and a half amps) may be a differential voltage between Vo and the cells of 0.280V by multiplying 2.5 A by 0.112Ω. One half of this voltage (0.140V) may appear across each loop 510, 512.

For example, if V_{T} has a value of 7.4V (3.7 volts for each cell), the Vo output voltage that will result in a balancing current of +2.5 A will be 3.840V (by adding 3.7V and 0.140V). This output voltage may correspond to a duty cycle of approximately 0.5189 (by dividing 3.840V by 7.4V).

The Vo output voltage that will result in a balancing current of −2.5 A will be 3.560V (by subtracting 3.7V minus 0.140V). This output voltage may correspond to a duty cycle of approximately 0.4811 (by dividing 3.560V by 7.4V).

Therefore, in this example, setting duty cycle limits of a maximum of 0.5189 on the high side and a minimum of 0.4811 on the low side may effectively limit the balancing current between +2.5 A and −2.5 A

Further, note that the calculations described in reference to this example may be applicable to a battery consisting of two cells in series. But if the battery has more than two cells in series, there will be additional current loops that are associated with SMDs that may be above or below the respective SMD under consideration. Current flowing through these adjacent loops will affect the current flowing in the balancing leg of the respective balancing loop under consideration.

Thus, in a battery with more than two cells in series, the balancing loop under consideration may need to be isolated from any cell balancing loops that are above or below it in the battery in order to characterize the impedance of the loop under consideration. This may be done by disabling (e.g., turning off the switches in) the SMDs above and below the SMD of the loop under consideration to isolate the loop under consideration. Accordingly, characterization of the limits of PWM duty cycle values in a battery with more than two cells in series may be achieved by disabling the adjacent SMDs above and below the SMD under consideration (e.g., by turning off the SMD completely and/or turning off its switches). This makes impedance very high in the adjacent control loops, which makes the adjacent control loops have negligible impact on the current flowing around the balancing loop under consideration.

For example, and referring to FIG. 5, to evaluate the PWM limits for setting Vo23 at SMD 23, the first step may be to disable SMD 12 and SMD 34. This may effectively disconnect V12− from Vo23 and effectively disconnect V34+ from Vo23. Then the calculations described above can be performed to establish the PWM values which will limit the current flowing in the respective balancing leg connected to Vo23.

Accordingly, the foregoing process of disabling SMDs above and below a subject SMD for setting the duty cycle limits of a subject SMD can be performed on any balancing loop that is associated with any subject SMD in the battery pack. For the SMD that is at the highest voltage position in the pack, it may only be necessary to disable the other SMD immediately below it. And for the SMD that is at the lowest voltage position in the pack, it may only be necessary to disable the other SMD immediately above it.

Further describing temperature correction as referenced above: The impedances of the SMD components (e.g., two transistors, inductor, capacitor, and connections), copper wire and connectors can vary with temperature. So that variations in impedance due to temperature fluctuations may be accounted for, note the following.

In many example embodiments, the impedance values of the circuit 18 may primarily be a function of copper conductors and semiconductor switch ON resistance, both of which may have a positive temperature coefficient. Therefore, the impedance values described above may decrease as the temperature decreases. Additionally, the cells may have a negative temperature coefficient which may at least partially offset the positive temperature coefficient of other elements of the circuit. The offsetting negative temperature coefficient of the cells may be relatively slight as battery cell impedance is typically a lower value than the impedance of components in the loop connected to the cell itself.

Thus, a balancing current limit value derived using the ILCS method above may be temperature dependent. Accuracy may be improved if temperature compensation of the impedance variation is employed. Temperature may be measured at the electronics and at the cells using temperature sensors. Since the impedance values of the balancing electronics may dominate over the impedance values of the battery cells, an overall positive temperature coefficient of the complete circuit (including the cells) may exist. Using impedance values that are associated with the lowest manufacturer-rated or manufacturer-specified operating temperature of the system may ensure that the balancing current is always less than the first threshold current magnitude since the current will invariably decrease as the temperature increases.

Contrasting the ILCS method as described above versus use of hardware current sensors (e.g., per FIG. 2), note that the total cost of a system using the ILCS method may be less than the cost of a system using hardware current sensors, since current sensors may be omitted from the balancing circuit when using the ILCS method. However, the ILCS method estimates balancing current in lieu of using current sensors and in some example instances may be less accurate than using hardware current sensors. Thus, relative to using hardware current sensors, the ILCS method in at least some instances may have a larger error term associated with the resulting Vo balancing current value and therefore may be compared to the second threshold current magnitude value mentioned above to provide a greater safety buffer to prevent overcurrent conditions. For example, if the ILCS method has an inherent error of ±20% for a given system, and if the maximum balancing current that the system can tolerate is 3 Amperes (the first threshold current magnitude described above), then the second threshold magnitude current may be set at 2.5 Amperes (positive or negative) or even less to assure that the actual balancing current (as opposed to the estimate of balancing current) does not exceed the 3-Ampere threshold.

Thus, the second threshold current magnitude value may be limited so as to stay safely away from and not exceed the design capabilities of the balancing hardware. The calculated (or estimated) magnitude of Vo when using ILCS may therefore be less precise than if current sensors are used, so the second threshold current magnitude value may be set such that the value of Vo yields a balancing leg current that is consistently restricted from exceeding the first threshold current magnitude value which could compromise the reliability or safety of the balancing system hardware.

Accordingly, the ILCS method of sensing balancing current can provide cost savings by eliminating the hardware current sensors 218 from the system, with possible reduced accuracy in some examples in the estimation of balancing current and with possible reduced accuracy in some examples in the estimation of cell characteristics (which may include cell state of health (SOH)). In general, changes in cell SOH can be caused in many instances by changes in cell capacity and changes in effective impedance of the cell, and so the greater accuracy of characterizing cell impedance that is afforded by hardware current sensors may enable more accurate characterization or estimation of cell characteristics such as state of health (SOH) in at least some examples.

In example embodiments where hardware current sensors are not used and the ILCS method is employed as a method of sensing balancing current, it may be useful to occasionally recalibrate the total loop impedance for the respective loop. Recalibration may involve periodic application of reference currents on the primary charge path to the complete string of cells in series when the battery is otherwise unloaded (e.g., not being used to power other systems external to the battery pack itself, such as a computer or vehicle) and when the battery is not being charged. The periodic application of reference currents for recalibration may be based on a recurring period of time recommended by the battery's manufacturer, such as every hour, every day, every week, every year, or even after a predetermined number of charge cycles greater than one (e.g., every five cycles or every few hundred cycles). The reference currents can be switched on at two or more known levels. For example, an initial reference current can be applied at 100% of the first current magnitude threshold and then a subsequent reference current can be applied at 50% of the first current magnitude threshold. Measuring the resulting cell voltages at the two or more reference currents using voltage sensors 210 may therefore be used to estimate effective impedance of the cells at any given time. Taking these measurements thus provides an updated estimate of the effective impedance of the cells for use in the ILCS mathematical model. The parameters of the Vo transfer function can thus be updated to compensate or correct for variations in cell impedance characteristics that occur over time and use of the battery.

For example, in a balancing system where 3 A establishes the first current magnitude threshold, the 100% reference level current (3.000 amperes) might produce a cell voltage of 3.850V depending upon the state of charge (SOC) of the cell. A 50% reference current (1.500 amperes) applied to the same impedance loop might produce a cell voltage of 3.843V. Subtracting 3.850V minus 3.843V yields a difference of 7 mV. In this example, the change in current of 1.5 A (3.0 A minus 1.5 A) may produce a differential voltage of 7 mV. Using Ohm's Law (7 mV/1.5 A), these measurements indicate a cell effective impedance of 4.67 mΩ. Using this reference current method, the effective impedance of the individual cells can be measured and then added to or subtracted from the total loop impedance of the Vo balancing leg and cell circuits.

The present application also recognizes that battery cell impedance may change over time such that cell impedance may increase as the cell continues to age. Using hardware current sensors, recalibration in response to changes in cell impedance may not be required since, in using hardware current sensors, any change in cell impedance can be characterized using the current sensors 218.

To reiterate, note that calibration may not be needed if the battery has and employs the hardware current sensors described above. Calibration (or recalibration) can optionally be performed when employing the ILCS method for balancing leg current sensing and limiting. In practice, recalibration may in some instances only be desirable to maintain the highest balancing leg current that is possible as cell impedance increases with age while providing a suitable safety buffer between second current magnitude threshold and the first current magnitude threshold. As cell impedance increases with age, current for cell balancing will correspondingly decrease over time, thus maintaining the limited maximum balancing leg current below the first current magnitude threshold in embodiments that employ ILCS without calibration. Thus, while employing ILCS, calibration or recalibration may not be needed to maintain safety, but it can be employed to keep the balancing leg current as high as possible as the cells degrade to allow the most efficient balancing of cells that is possible for a given age of the battery. Without recalibration, ILCS may still be used and be effective at estimating balancing leg current but may in some instances keep balancing leg current at less than maximum possible values as time goes on.

The above methods may be implemented as software instructions executed by a controller 220 such as a processor, a suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

One or more embodiments of the invention enable an apparatus and method for the near real-time measurement of bipolar charge and discharge impedance of each cell in a series stack of cells in a battery. These measurements can occur while the battery is charging, while it is discharging, or when the battery is in a quiescent state.

Now referring to FIG. 2A which is an amendment to and should be read in conjunction with FIG. 2.

The controller 220 is interfaced to multiple SMD 200, 214, and 216. The SMD's allow for selective impedance measurement and charging of the individual cells 219, 221, 223, 225. The system 18 allows measurement of individual impedances of cells 219, 221, 223, 225 in the series stack. If cells 219, 221, 223, 225 consist of a string of individual cells connected in parallel, the parallel strings of cells are treated as one larger cell.

Individual cell 219, 221, 223, 225 impedances are measured in cell pairs (219-221, 221-223, 223-225). Each SMD 200, 214, 216 is connected to two cells, an upper cell (most positive) and a lower cell (most negative). Each SMD 200, 214, 216 is connected in an overlapping series string, so if multiple SMD 200, 214, 216 are simultaneously active the individual cell currents (209⇔208, 208⇔231, 231⇔233, 233⇔207) will be a function of the states of active SMD 200, 214, 216 and their associated cells. Therefore, to measure individual cell currents, the SMD 200, 214, 216 must be isolated and treated individually. Individual cell currents can be measured using any reference current up to and including the maximum permitted balancing current only limited by the physical characteristics of each cell and the design limits of the SMD circuitry.

Impedances of individual cells can be measured by dividing cell voltage measurements by respective cell current measurements. Cell voltages can be measured with voltage sensors 210. Cell current measurements can be obtained from the current sensors 218 on the balancing legs 212. These cell voltage and cell current measurements can be taken periodically at a rate to determine impedance for each cell. The voltage and current sensors enable the system to measure cell impedance while the battery is use. For example, cell impedance can be measured while the battery is in a vehicle. This can be done automatically and does not require any additional measurement equipment.

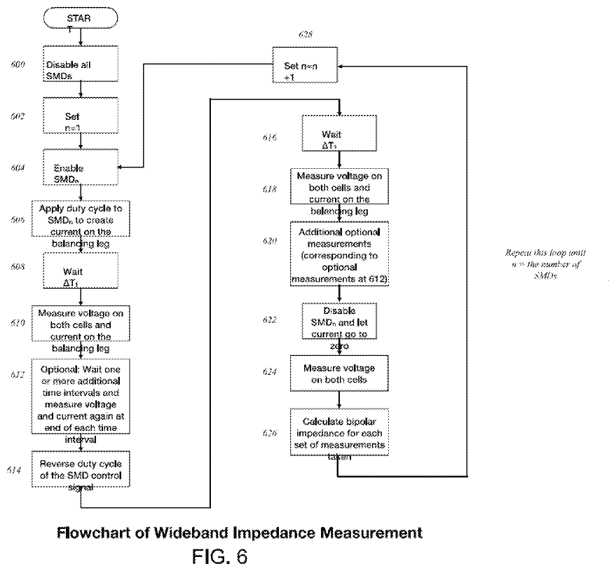

The method of taking these measurements is illustrated by the method shown in the flowchart of FIG. 6. These measurement steps are as follows:
Step 1 (600)—Disable all SMD 200, 214, 216, by opening all connections of each SMD 200, 214, 216, allowing each of the balancing legs 212 to reach zero current.
Step 2 (602)— Select a first SMD to use for cell impedance measurement
Step 3 (604)—Enable the first SMD 200,
Step 4 (606)—Apply a first SMD duty cycle, creating a current on the balancing leg 212, a charge current in one of the connected cells and a discharge current in the other connected cell. This causes a rise in voltage in the cell receiving a charge current and a drop in voltage in the cell receiving a discharge current.
Step 5 (608)— Wait a fixed known time interval following activation of the SMD 200.
Step 6 (610)—Measure voltage on both cells that are connected to the SMD 200 and measure current on the current sensor 218 on the SMD's balancing leg 212.
Step 6a (612)— Additional measurements of voltage and current of the cells that are connected to the SMD 200 can optionally be made following one or more subsequent time intervals of known duration(s).
Step 7 (614)—Reverse the duty cycle of the control signal to the SMD 200 to reverse the charge and discharge currents to the two connected cells.
Step 8 (616)— Wait the same time interval as in Step 5
Step 9 (618)—Measure voltage on both cells that are connected to the SMD 200 and measure current on the current sensor 218 on the SMD's balancing leg 212.
Step 9a (620)—If additional measurements of voltage and current were made in step 6a (612), take additional measurements of voltage and current on the same time schedule as the measurements that were taken in step 6a (612).
Step 10 (622)— Disable the SMD 200 so that there is no charge or discharge current on the connected cells.
Step 11 (624)—Measure voltage on the two connected cells. This is measurement of cell voltage at zero current.
Step 12 (626)—Use Ohm's law (R=E/I) to calculate bipolar cell impedance. The charge cell impedance for each connected cell is calculated as the difference in cell voltage between voltage at charge current and voltage at zero current divided by the charge current. Similarly, the discharge cell impedance for each connected cell is calculated as the difference in cell voltage between voltage at discharge current and voltage at zero current divided by the discharge current. If plural sets of measurements were taken at steps 6 (612) and 9 (618), repeat these calculations for each set of measurements from steps 6 (612) and 9 (618) that were taken at corresponding (or matching) time intervals following the start of the reference current.

These steps may be repeated for each SMD in the battery pack to obtain measurements of bipolar impedance for each cell in the stack.

When cells are manufactured, impedance measurements are typically made on each individual cell. For example, a cell manufacturer may measure DC resistance and AC impedance at 1 kHz on each cell. One or more embodiments of the invention can take wide bandwidth bipolar AC impedance measurements of cells in the series stack while the battery is being used in the end product, such as an electric vehicle. This allows these critical measurements to be performed over the entire life of the cells while being used in the field.

In an illustrated example to measure AC impedance at a frequency of approximately 1 kHz: About 0.5 ms following the start of the first reference current, measure voltage and current on both cells, then reverse the reference current. About 0.5 ms after reversing the reference current, measure voltage and impedance of both cells again. Then disable the SMD and measure voltage of both cells with zero current. Then calculate bipolar impedance using Ohm's Law as described in step 12.

Multiple measurements of voltage and current during each interval of reference current (positive and negative) allow calculations of AC impedance at more than one frequency. For example, if a measurement is taken about 0.5 ms following the start of each reference current interval, these measurements will yield approximately 1 kHz AC impedance. If another measurement is taken about 1 ms following the start of each reference current interval, these measurements will yield approximately 500 Hz AC impedance.

Impedance frequencies can be characterized from DC to any higher frequency that is adequately lower than the SMD switching frequency and also adequately lower than the resonant frequency of the SMD filter. Typical SMD switching frequencies range from 100 kHz to 400 kHz in one or more embodiments of the invention that may have a maximum balancing current of 4 A. A ratio of about twenty to one (between SMD switching frequency and impedance frequency) may provide adequate accuracy. For a nominal 200 kHz SMD system, impedance measurements can be made from DC to about 10 kHz (200 kHz/20). The resonant frequency of the SMD LC filter will affect the ripple level of the SMD output current. The magnitude of ripple current applied to the cells can affect cell performance. Higher ripple currents may degrade cell performance. A typical LC filter for use with a 200 kHz SMD can be approximately 8 kHz. Impedance frequencies adequately lower than the filter resonant frequency may provide higher signal levels for the cell voltage and current measurements. For this example, an LC filter resonant frequency of 8 kHz may provide adequate AC signal levels for impedance measurements up to 2 kHz. Cell voltage measurements may have a bandwidth from five to ten times the highest desired impedance frequency to provide adequate voltage measurement accuracy. For example, to measure impedance at frequencies up to 1 kHz, voltage sensors may have a bandwidth of 5 kHz to 10 kHz to provide adequate accuracy. Relationships between filter frequency response and signal levels are well understood in the art of signal processing.

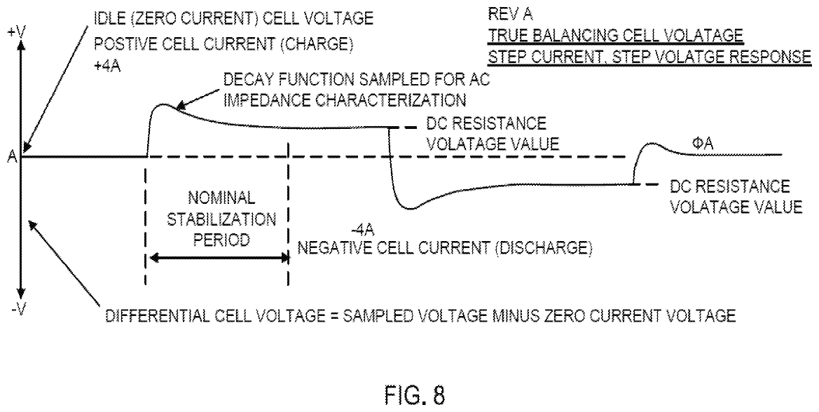

FIG. 8 illustrates an exemplary voltage waveform that may be generated by the impedance measurement method described above. The voltage waveform 802 shows characteristic rises and falls in voltage that occur when steps 4 (606), 8 (614) and 12 (622) are performed. The voltage waveform 802 as shown in FIG. 8 applies to a connected cell that receives a positive charge in step 4 (606). The curve for the other connected cell will be approximately an inverse of the curve in FIG. 8 but will not be an exact inverse as each cell has different characteristics.

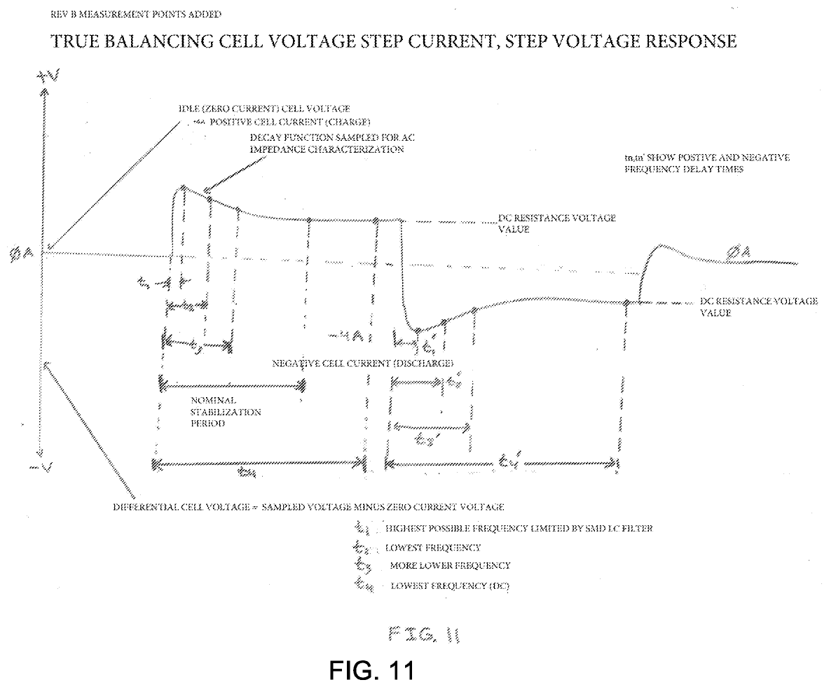

FIG. 11 illustrates an example of timing the measurements of voltage and current that may be taken to calculate cell impedance in one or more embodiments of the invention. After a first duty cycle is applied at step 4 (606), a first set of measurements may be taken at the time indicated as T₁ in FIG. 11. This measurement is taken at the peak of the voltage pulse, and may represent a highest frequency measurement that may provide accurate measurements to calculate cell impedance. The duration of time interval T₁ is typically determined by the frequency of the LC filter described above.

Another measurement may be taken at time T₂. To measure AC impedance of 1 kHz, the duration of time interval T₂ may be 0.5 ms. Yet another measurement may be taken at time T₃. To measure AC impedance of 500 Hz, the duration of time interval T₃ may be 1.0 ms.

When the SMD duty cycle is reversed at step 8 (614), the waveform essentially inverts. A new set of measurements may be taken at time intervals shown as T′₁, T′₂ and T′₃. These time intervals will typically be equal or nearly equal to corresponding time intervals T₁, T₂ and T₃.

As another example, to measure cell DC resistance: Start the first reference current. Wait a sufficient amount of time to allow the slope of the voltage decay curve shown in FIG. 11 to become essentially zero. This is shown as time interval T₄ in FIG. 11. This amount of time is called the DC stabilization period. The DC stabilization period will vary depending on parameters such as cell chemistry and size of the cells as well as the SMD LC filter frequency. When the DC stabilization period has transpired, measure voltage and current on both cells. Reverse the reference current and wait again for the DC stabilization period (T′₄) to transpire. Then measure voltage and current on both cells again. Finally, disable the SMD 200 and measure voltage on both cells with zero current, then perform the calculations in step 12 (626) to determine bipolar DC resistance of the cells.

If a maximum balancing current of 4 Amperes, for example, has been established for a specific battery system, then impedance measurements can be made with reference currents of positive 4 Amperes and negative 4 Amperes. In general, the greater the reference current, the greater the accuracy of impedance measurement, so typically the maximum supported balancing current will be generated as the reference current for measuring cell impedance. However, reference currents less than maximum balancing current can be used.

If the target reference current is 4 Amperes, for example, it is not necessary for the actual reference current to be exactly 4 Amperes. The control system 200 will know how to modulate the SMDs to create a balancing current of approximately 4 A, and then actual current is measured using the current sensor to allow an accurate calculation of impedance. Similarly, the positive and negative reference currents do not need to be identical in magnitude; they just need to be similar to each other to allow a sufficiently accurate calculation of bipolar impedance. As a non-limiting example, a difference of ±10% in magnitude between the positive and negative balancing currents may allow sufficiently accurate calculation of impedance.

The sequence in which reference currents are applied does not need to be the exact sequence described above. For example, the first reference current can be zero, followed by a positive and then negative reference current. Or a positive reference current can be applied, followed by zero reference current, and finally negative reference current. Note that “positive” and “negative” are relative terms in this description. A positive current to one of the connected cells will be a negative current to the other connected cell. That does not affect this description, because for every set of bipolar impedance measurements, both connected cells will experience positive, negative and zero reference currents. The application of positive and negative current will be opposite for the two cells; the application of zero current will be the same for both cells.

By taking multiple measurements during each reference current interval, it is possible to capture data that can be used to approximate the shape of the voltage decay curves of the cells. This is useful (in addition to the utility of capturing individual impedance measurements) as it provides information on how the voltage decay curves change as the battery is used and as the battery ages.

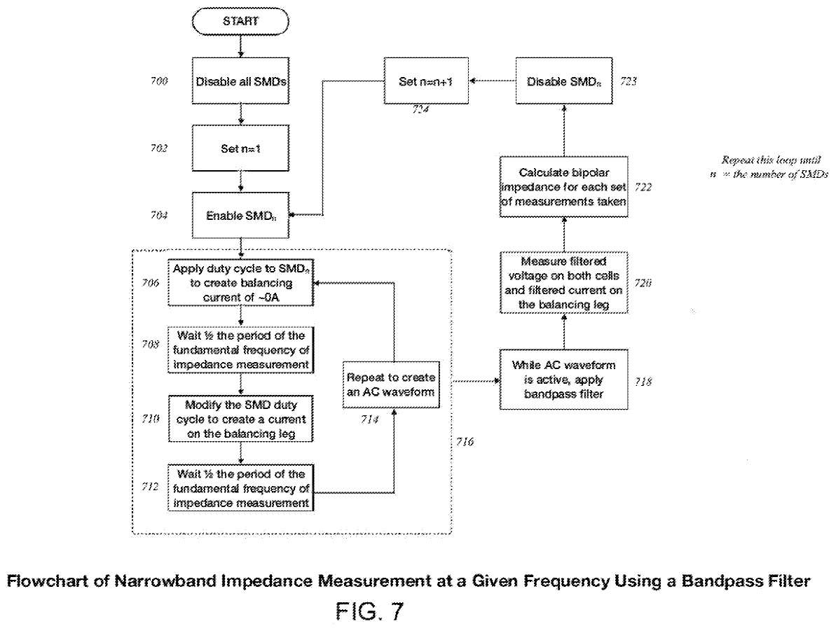

Now referring to FIG. 7 which describes a method for the measure of bipolar impedance of cells at a single frequency. Measuring at a single frequency (narrowband) improves the signal-to-noise ratio (SNR) of measurements of cell voltage and current. Improvement in SNR by reduction of bandwidth is well known in the art of signal processing technique.

Measurement of narrowband bipolar impedance of cells at a single (fundamental) frequency can be performed as follows:
Step 1 (700)—Disable all SMDs, meaning both switches are open in all SMDs, and all balancing legs are at zero current.
Step 2 (702)— Select a first SMD 200 to use for cell impedance measurement
Step 3 (704)—Enable the first SMD 200,
Step 4 (706)—Apply a first SMD duty cycle to create a balancing current of approximately 0 A. If the voltages of the two respective cells are nearly equal, a duty cycle of 0.5 (50% duty cycle) may create a balancing current of nearly 0 A. If a duty cycle of 0.5 does not create a balancing current that is nearly 0 A (which may be determined by sampling the current sensor (218)) the duty cycle may be adjusted until the current sensor (218) indicates that balancing current is nearly 0 A.

When the balancing current is at or near zero, the average current in each of the two cells will also be at or very near zero. The average voltage of each cell is now approximately equal to the voltage of the cell when the SMD is disabled.
Step 5 (708)—Maintain this duty cycle for one half the period of the fundamental frequency of the impedance measurement.
Step 6 (710)—Adjust the SMD duty cycle to create a current on the balancing leg (212), a charge current in one of the connected cells, and a discharge current in the other connected cell. This causes a rise in voltage in the cell receiving a charge current and a drop in voltage in the cell receiving a discharge current.
Step 7 (712)—Maintain this duty cycle for one half the period of the fundamental frequency of the impedance measurement.

Repeat steps 4 (706) through 7 (712) continuously. This creates an alternating current between the zero current state and the charge/discharge current state. This pattern of SMD modulation will create a continuous excitation current in the two cells at a fundamental frequency that is determined by the sum of the two periods of the switching states in steps 5 (708) and 7 (712), one cell switching from zero current to charge current and the other cell switching from zero current to discharge current. Measure the continuous excitation current in the two cells.

A description of noise that may be present in the AC waveform is now presented, as is a description of how filtering may reduce the noise and improve signal-to-noise ratio (SNR). Following this description, the description of FIG. 7 resumes.

The voltage signal at each cell and the excitation current on the balancing leg may be a waveform at the fundamental frequency. This waveform may have harmonics, SMD ripple and noise at frequencies above the fundamental frequency of the impedance measurement. These higher frequencies may be reduced by passing the voltage and current signals through a low pass filter having a corner frequency approximately equal to the impedance measurement frequency.

If noise signals are present below the fundamental frequency, a high pass filter may be alternatively or additionally employed to likewise reduce lower frequency components.

A bandpass filter may be employed to reduce noise at frequencies above and below the fundamental frequency. The narrower passband created by the use of such filters can remove a large portion of the higher noise and harmonic frequencies and/or the lower noise frequencies. This can provide improved cell voltage and excitation current signals at the fundamental frequency, which can increase the signal-to-noise ratio (SNR) of voltage and current measurements.

Returning now to the description of FIG. 7:
Step 8 (718)—While the AC waveform is active, apply filtering to the waveform, which can be high pass or low pass or bandpass filtering. As an illustrative example, FIG. 7 mentions bandpass filtering.
Step 9 (720)—Measure the filtered voltage on the respective cells and the filtered current on the respective balancing leg (212).
Step 10 (722)—Use Ohm's law (R=E/I) to calculate bipolar cell impedance as previously described.

Steps 1 through 10 may be repeated for each SMD in the battery stack.

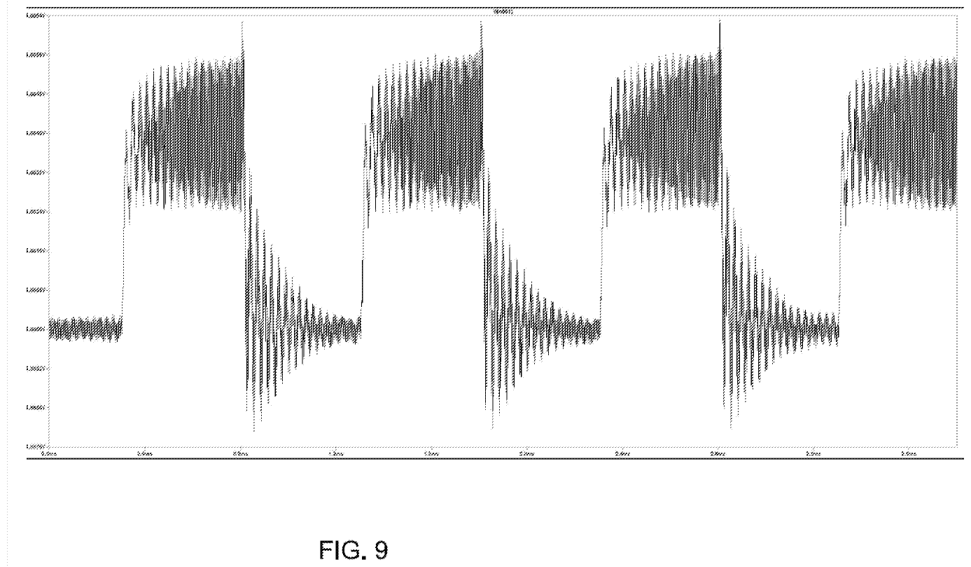

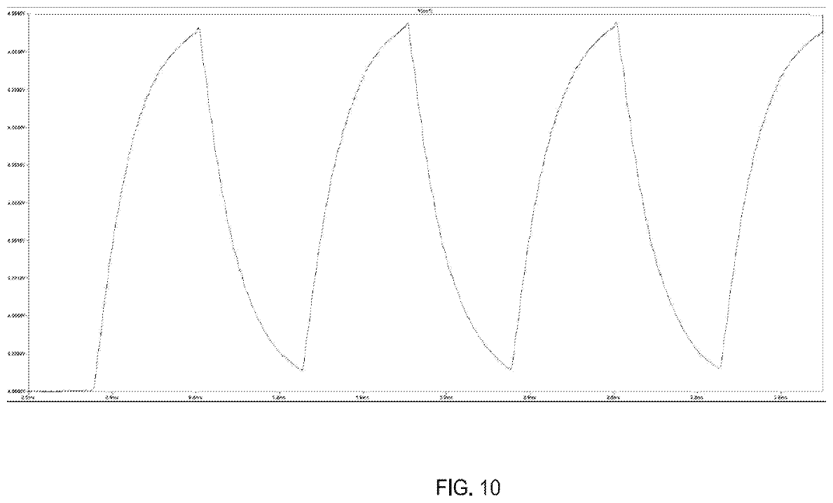

FIG. 9 shows an example of what an unfiltered waveform may look like when this method is used to measure cell impedance. FIG. 10 shows what the waveform may look like after filtering.

Because the current and voltage signals are AC waveforms, the RMS value of each may provide a more accurate measurement. In a practical system, calibration may be performed using precise reference resistors inserted in series with the cells or in place of the cells to generate reference levels of impedance and voltage.

As is described in the description of wideband impedance measurements, the charge and discharge currents will not be precisely equal because the SMD operation will have some small finite energy loss. In order to improve the accuracy of measurements of charge/discharge impedance, the SMD duty cycle that is generated at step 3 may be reversed in order to reverse the excitation current signals so that the charge and discharge directions for the two cells are reversed. The two voltage measurements of each cell and the excitation current may then be averaged, peak detected or otherwise filtered to improve the accuracy of the impedance calculation (722).

While employing a sampling system to measure signal amplitude of the fundamental frequency, the sampling rate must exceed the desired resolved fundamental frequency according to the Nyquist criterion.

It will be appreciated that whilst present principals have been described with reference to some example embodiments, these are not intended to be limiting, and that various alternative arrangements may be used to implement the subject matter claimed herein.

What is claimed is:

1. An assembly, comprising:
at least one switch mode divider (SMD) connectable in parallel to a junction between two respective battery cells connected in series, and operable to equalize voltages among plural battery cells based on signals from at least one voltage sensor, the SMD being characterized by an output voltage Vo that is a function of a duty cycle of a drive waveform and high and low rail voltages; and
at least one circuit that generates a signal representative of current on a balancing leg associated with the at least one SMD to enable the SMD to limit current from the SMD to at least one of the battery cells during charging.

2. The assembly of claim 1, wherein the circuit comprises a current sensor that generates the signal based on current sensed by the current sensor.

3. The assembly of claim 1, wherein the circuit comprises a controller that generates the signal based on an estimation of current.

4. The assembly of claim 3, wherein the controller uses Ohm's law to estimate the current.

5. The assembly of claim 3, wherein the controller modulates the at least one SMD based on the estimation to limit current through at least one balancing leg associated with the at least one SMD to be no more than a threshold current magnitude.

6. The assembly of claim 5, wherein the threshold current magnitude is a second threshold current magnitude, and wherein the second threshold current magnitude is a predetermined amount less than a first threshold current magnitude at which battery cell stress may occur.

7. The assembly of claim 6, wherein the controller is preprogrammed with the second threshold current magnitude.

8. The assembly of claim 3, wherein the estimation of current is based at least in part on at least one estimation of impedance for at least part of the assembly.

9. The assembly of claim 8, wherein the estimation of impedance is based at least in part on at least one temperature coefficient to estimate change in impedance at a given temperature.

10. The assembly of claim 9, wherein temperature is sensed for estimating changes in impedance due to changes in temperature using at least one temperature sensor in the assembly.

11. The assembly of claim 10, comprising at least one temperature sensor and comprising the plural battery cells.

12. The assembly of claim 11, wherein the temperature sensor senses temperature of electronics.

13. An apparatus, comprising:
at least first and second battery cells arranged in electrical series with each other and defining a primary charge/discharge path;
a balancing circuit arranged in electrical parallel with the primary charge/discharge path, the balancing circuit comprising:
a voltage sensor line and;
at least one cell junction between respective adjacent battery cells connected in series; and
at least one voltage sensor;
a respective switch mode divider (SMD) connected to a respective cell junction;
at least one controller controlling the respective SMDs to equalize voltages among battery cells.

14. The apparatus of claim 13, comprising:
a respective current sensor electrically connected to a respective balancing leg and useful to enable the respective SMD to limit current through the respective balancing leg to which the current sensor is connected.

15. The apparatus of claim 13, wherein the controller controls the respective SMD to limit current through the respective balancing leg based on an estimation of current in the respective balancing leg.

16. The apparatus of claim 15, wherein the estimation of current in the respective balancing leg is based at least in part on a characteristic impedance of the respective balancing leg.

17. A method, comprising:
modulating at least one switch mode divider (SMD) associated with respective battery cells connected in series to equalize voltage among the battery cells, the SMD characterized by being driven by a constant period signal having an ON time and OFF time, the sum of which equals to a total constant period; and
limiting current in at least one balancing leg associated with the at least one SMD to satisfy a threshold.

18. The method of claim 17, wherein balancing is executed only after at least one battery cell reaches full charge voltage during battery charge.

19. The method of claim 17, comprising limiting current in at least one balancing leg associated with the at least one SMD to satisfy a threshold at least in part using a current sensor that provides input to a controller, and comprising using the controller to modulate the SMD to limit current in the at least one balancing leg to a threshold based on the input from the current sensor.

20. The method of claim 17, comprising limiting current in at least one balancing leg associated with the at least one SMD to satisfy a threshold during battery discharge.

21. An assembly, comprising:
A voltage sensor;
at least one switch mode divider (SMD) connectable to a junction between two battery cells connected in series, and operable to determine voltages from said voltage sensor and equalize voltages between plural cells during charging or discharging of the cells; and
at least one current sensor on a balancing leg associated with the at least one SMD to enable the SMD to limit current from the SMD to at least one of the cells during charging or discharging.

22. The assembly of claim 21, comprising the battery cells, the battery cells comprising Lithium-ion cells.

23. A method, comprising:
modulating at least one switch mode divider (SMD) associated with respective battery cells to equalize voltage between the cells during battery charge or discharge; and
limiting current in at least one balancing leg associated with the at least one SMD to satisfy a threshold.

24. The method of claim 23, wherein at least the balancing is executed only after at least one cell reaches full charge voltage during battery charge.

25. The method of claim 23, comprising limiting current in at least one balancing leg associated with the at least one SMD to satisfy a threshold at least in part using a current sensor providing input to a controller and using the controller to modulate the SMD to limit current in the at least one balancing leg to a threshold based on the input from the current sensor.

26. The method of claim 23, comprising limiting current in at least one balancing leg associated with the at least one SMD to satisfy a threshold during battery discharge.

27. The method of claim 17, comprising recalibrating by periodic application of reference currents on a primary charge path to the cells when the battery is otherwise unloaded and not being charged.

28. The method of claim 17, comprising turning on balancing prior to any cell reaching full charge voltage.
